(19) United States
(12) Patent Application Publication
(10) Pub. No.: US 2017/0317794 A1
(43) Pub. Date: Nov. 2, 2017

(54) METHOD AND USER EQUIPMENT FOR TRANSMITTING UPLINK SIGNAL, AND METHOD AND BASE STATION FOR RECEIVING UPLINK SIGNAL

(71) Applicant: LG ELECTRONICS INC., Seoul (KR)

(72) Inventors: Hyangsun YOU, Seoul (KR); Yunjung YI, Seoul (KR)

(73) Assignee: LG ELECTRONICS INC., Seoul (KR)

(21) Appl. No.: 15/581,652

(22) Filed: Apr. 28, 2017

Related U.S. Application Data
(60) Provisional application No. 62/329,205, filed on Apr. 29, 2016.

(51) Int. Cl. H04L 5/00; H04W 72/04

(52) U.S. Cl. CPC H04L 5/005; H04W 72/0446; H04W 72/0453

(57) ABSTRACT

Disclosed herein are a method and apparatus for transmitting/receiving an uplink signal. A user equipment transmits a first uplink channel within a first transmission time interval (TTI); transmits a second uplink channel within a second TTI; and transmits a first demodulation reference signal (DMRS) for the first uplink channel and a second DMRS for the second uplink channel on a same time symbol. The user equipment generates the first DMRS and the second DMRS based on a same TTI index.

### CROSS-REFERENCE TO RELATED APPLICATIONS

Pursuant to 35 U.S.C. §119(e), this application claims the benefit of U.S. Provisional Patent Application No. 62/329,205, filed on Apr. 29, 2016, the contents of which are hereby incorporated by reference herein in its entirety.

### TECHNICAL FIELD

The present invention relates to a wireless communication system, and more particularly, to a method and apparatus for transmitting/receiving uplink signals.

### BACKGROUND ART

With appearance and spread of machine-to-machine (M2M) communication and a variety of devices such as smartphones and tablet PCs and technology demanding a large amount of data transmission, data throughput needed in a cellular network has rapidly increased. To satisfy such rapidly increasing data throughput, carrier aggregation technology, cognitive radio technology, etc. for efficiently employing more frequency bands and multiple input multiple output (MIMO) technology, multi-base station (BS) cooperation technology, etc. for raising data capacity transmitted on limited frequency resources have been developed.

A general wireless communication system performs data transmission/reception through one downlink (DL) band and through one uplink (UL) band corresponding to the DL band (in case of a frequency division duplex (FDD) mode), or divides a prescribed radio frame into a UL time unit and a DL time unit in the time domain and then performs data transmission/reception through the UL/DL time unit (in case of a time division duplex (TDD) mode). A base station (BS) and a user equipment (UE) transmit and receive data and/or control information scheduled on a prescribed time unit basis, e.g. on a subframe basis. The data is transmitted and received through a data region configured in a UL/DL subframe and the control information is transmitted and received through a control region configured in the UL/DL subframe. To this end, various physical channels carrying radio signals are formed in the UL/DL subframe. In contrast, carrier aggregation technology serves to use a wider UL/DL bandwidth by aggregating a plurality of UL/DL frequency blocks in order to use a broader frequency band so that more signals relative to signals when a single carrier is used can be simultaneously processed.

In addition, a communication environment has evolved into increasing density of nodes accessible by a user at the periphery of the nodes. A node refers to a fixed point capable of transmitting/receiving a radio signal to/from the UE through one or more antennas. A communication system including high-density nodes may provide a better communication service to the UE through cooperation between the nodes.

As more and more communication devices require greater communication capacity, there is a need for improved mobile broadband communication over legacy radio access technology (RAT). In addition, massive machine type communication (mMTC) for connecting multiple devices and objects to each other to provide various services anytime and anywhere is one of the major issues to be considered in next generation communication.

There is also a discussion on communication systems to be designed in consideration of reliability and latency-sensitive services/UEs. Introduction of next generation radio access technology is being discussed in terms of improved mobile broadband communication (eMBB), mMTC, and ultra-reliable and low latency communication (URLLC).

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

With development of technologies, overcoming delay or latency has become an important challenge. Applications whose performance critically depends on delay/latency are increasing. Accordingly, a method to reduce delay/latency compared to the legacy system is demanded.

Also, with development of smart devices, a new scheme for efficiently transmitting/receiving a small amount of data or efficiently transmitting receiving data occurring at a low frequency is required.

In addition, a system for transmitting/receiving signals in a system supporting a new radio access technology is required.

The technical objects that can be achieved through the present invention are not limited to what has been particularly described hereinabove and other technical objects not described herein will be more clearly understood by persons skilled in the art from the following detailed description.

### SUMMARY

To achieve these objects and other advantages and in accordance with the purpose of the invention, as embodied and broadly described herein, provided herein is a method for transmitting an uplink signal by a user equipment in a wireless communication system. The method includes transmitting a first uplink channel within a first transmission time interval (TTI), transmitting a second uplink channel within a second TTI, and transmitting a first demodulation reference signal (DMRS) for the first uplink channel and a second DMRS for the second uplink channel in a same time symbol. The first DMRS and the second DMRS may be generated based on a same TTI index.

In another aspect of the present invention, provided herein is a user equipment for transmitting an uplink signal in a wireless communication system. The user equipment includes a radio frequency (RF) unit, and a processor configured to control the RF unit. The processor is configured to control the RF unit to transmit a first uplink channel within a first transmission time interval (TTI), control the RF unit to transmit a second uplink channel within a second TTI, and control the RF unit to transmit a first demodulation reference signal (DMRS) for the first uplink channel and a second DMRS for the second uplink channel in a same time symbol. The processor may generate the first DMRS and the second DMRS based on a same TTI index.

In another aspect of the present invention, provided herein is a method for receiving an uplink signal by a base station in a wireless communication system. The method includes receiving a first uplink channel from a user equipment within a first transmission time interval (TTI), receiving a second uplink channel from the user equipment within a second TTI, and receiving a first demodulation reference signal (DMRS) for the first uplink channel and a second DMRS for the second uplink channel from the user equipment in a same time symbol. The first DMRS and the second DMRS may be detected based on a same TTI index.

In another aspect of the present invention, provided herein is a base station for receiving an uplink signal in a wireless communication system. The base station includes a radio frequency (RF) unit, and a processor configured to control the RF unit. The processor is configured to control the RF unit to receive a first uplink channel from a user equipment within a first transmission time interval (TTI), control the RF unit to receive a second uplink channel from the user equipment within a second TTI, and control the RF unit to receive a first demodulation reference signal (DMRS) for the first uplink channel and a second DMRS for the second uplink channel from the user equipment in a same time symbol. The processor may detect the first DMRS and the second DMRS based on a same TTI index.

In the respective aspects of the present invention, the same time symbol may be a last time symbol in the first TTI and a start time symbol in the second TTI.

In the respective aspects of the present invention, the same TTI index may be an index of the first TTI, an index of the second TTI, floor(the index of the first TTI/2), floor(the index of the second TTI/2), ceil(the index of the first TTI/2), or ceil(the index of the second TTI/2).

In the respective aspects of the present invention, information about a first frequency resource for the first uplink channel, information about a second frequency resource for the second uplink channel, and information about a third frequency resource for a DMRS may be provided to the user equipment.

In the respective aspects of the present invention, the first uplink channel may be transmitted using the first frequency resource within the first TTI, the second uplink channel may be transmitted using the second frequency resource within the second TTI, and the first DMRS and the second DMRS may be transmitted using the third frequency resource within the same time symbol.

According to the present invention, uplink/downlink signals can be efficiently transmitted/received. Therefore, overall throughput of a radio communication system can be improved.

According to one embodiment of the present invention, a low cost/complexity UE can perform communication with a BS at low cost while maintaining compatibility with a legacy system.

According to one embodiment of the present invention, the UE can be implemented at low cost/complexity.

According to one embodiment of the present invention, the UE and the BS can perform communication with each other at a narrowband.

According to an embodiment of the present invention, delay/latency occurring during communication between a user equipment and a base station may be reduce.

In addition, with development of smart devices, a small amount of data or data which are less frequently generated may be efficiently transmitted/received.

Signals may be transmitted/received in a system supporting a new radio access technology.

According to an embodiment of the present invention, a small amount of data may be efficiently transmitted/received.

### BRIEF DESCRIPTION OF THE DRAWING

The accompanying drawings, which are included to provide a further understanding of the invention, illustrate embodiments of the invention and together with the description serve to explain the principle of the invention.

FIG. 1 illustrates the structure of a radio frame used in a wireless communication system.

FIG. 2 illustrates the structure of a downlink (DL)/uplink (UL) slot in a wireless communication system.

FIG. 3 illustrates the structure of a DL subframe used in a wireless communication system.

FIG. 4 illustrates the structure of a UL subframe used in a wireless communication system.

FIG. 5 illustrates configuration of cell specific reference signals (CRSs) and user specific reference signals (UE-RS).

FIG. 6 illustrates multiplexing of uplink control information and uplink data in the PUSCH region.

FIG. 7 illustrates the length of a transmission time interval (TTI) which is needed to implement low latency.

FIG. 8 illustrates an sTTI and transmission of a control channel and data channel within the sTTI.

FIG. 9 illustrates an example of short TTIs configured in a legacy subframe.

FIG. 10 illustrates a self-contained subframe structure.

FIG. 11 illustrates an example of application of analog beamforming.

FIG. 12 illustrates an uplink demodulation reference signal according to an embodiment of the present invention.

FIG. 13 is a block diagram illustrating elements of a transmitting device 10 and a receiving device 20 for implementing the present invention.

### DETAILED DESCRIPTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, puncturing a channel on a specific resource means that the signal of the channel is mapped to the specific resource in the procedure of resource mapping of the channel, but a portion of the signal mapped to the punctured resource is excluded in transmitting the channel. In other words, the specific resource which is punctured is counted as a resource for the channel in the procedure of resource mapping of the channel, a signal mapped to the specific resource among the signals of the channel is not actually transmitted. The receiver of the channel receives, demodulates or decodes the channel, assuming that the signal mapped to the specific resource is not transmitted. On the other hand, rate-matching of a channel on a specific resource means that the channel is never mapped to the specific resource in the procedure of resource mapping of the channel, and thus the specific resource is not used for transmission of the channel. In other words, the rate-matched resource is not counted as a resource for the channel in the procedure of resource mapping of the channel. The receiver of the channel receives, demodulates, or decodes the channel, assuming that the specific rate-matched resource is not used for mapping and transmission of the channel.

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell. Furthermore, channel status/quality of a specific cell refers to channel status/quality of a channel or communication link formed between an eNB or node which provides a communication service to the specific cell and a UE. The UE may measure DL channel state received from a specific node using cell-specific reference signal(s) (CRS(s)) transmitted on a CRS resource and/or channel state information reference signal(s) (CSI-RS(s)) transmitted on a CSI-RS resource, allocated by antenna port(s) of the specific node to the specific node. Detailed CSI-RS configuration may be understood with reference to 3GPP TS 36.211 and 3GPP TS 36.331 documents.

Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the 3GPP LTE-A standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

3GPP LTE/LTE-A standards define DL physical channels corresponding to resource elements carrying information derived from a higher layer and DL physical signals corresponding to resource elements which are used by a physical layer but which do not carry information derived from a higher layer. For example, a physical downlink shared channel (PDSCH), a physical broadcast channel (PBCH), a physical multicast channel (PMCH), a physical control format indicator channel (PCFICH), a physical downlink control channel (PDCCH), and a physical hybrid ARQ indicator channel (PHICH) are defined as the DL physical channels, and a reference signal and a synchronization signal are defined as the DL physical signals. A reference signal (RS), also called a pilot, refers to a special waveform of a predefined signal known to both a BS and a UE. For example, a cell-specific RS (CRS), a UE-specific RS (UE-RS), a positioning RS (PRS), and channel state information RS (CSI-RS) may be defined as DL RSs. Meanwhile, the 3GPP LTE/LTE-A standards define UL physical channels corresponding to resource elements carrying information derived from a higher layer and UL physical signals corresponding to resource elements which are used by a physical layer but which do not carry information derived from a higher layer. For example, a physical uplink shared channel (PUSCH), a physical uplink control channel (PUCCH), and a physical random access channel (PRACH) are defined as the UL physical channels, and a demodulation reference signal (DM RS) for a UL control/data signal and a sounding reference signal (SRS) used for UL channel measurement are defined as the UL physical signals.

In the present invention, a physical downlink control channel (PDCCH), a physical control format indicator channel (PCFICH), a physical hybrid automatic retransmit request indicator channel (PHICH), and a physical downlink shared channel (PDSCH) refer to a set of time-frequency resources or resource elements (REs) carrying downlink control information (DCI), a set of time-frequency resources or REs carrying a control format indicator (CFI), a set of time-frequency resources or REs carrying downlink acknowledgement (ACK)/negative ACK (NACK), and a set of time-frequency resources or REs carrying downlink data, respectively. In addition, a physical uplink control channel (PUCCH), a physical uplink shared channel (PUSCH) and a physical random access channel (PRACH) refer to a set of time-frequency resources or REs carrying uplink control information (UCI), a set of time-frequency resources or REs carrying uplink data and a set of time-frequency resources or REs carrying random access signals, respectively. In the present invention, in particular, a time-frequency resource or RE that is assigned to or belongs to PDCCH/PCFICH/PHICH/PDSCH/PUCCH/PUSCH/PRACH is referred to as PDCCH/PCFICH/PHICH/PDSCH/PUCCH/PUSCH/PRACH RE or PDCCH/PCFICH/PHICH/PDSCH/PUCCH/PUSCH/PRACH time-frequency resource, respectively. Therefore, in the present invention, PUCCH/PUSCH/PRACH transmission of a UE is conceptually identical to UCI/uplink data/random access signal transmission on PUSCH/PUCCH/PRACH, respectively. In addition, PDCCH/PCFICH/PHICH/PDSCH transmission of an eNB is conceptually identical to downlink data/DCI transmission on PDCCH/PCFICH/PHICH/PDSCH, respectively.

Hereinafter, OFDM symbol/subcarrier/RE to or for which CRS/DMRS/CSI-RS/SRS/UE-RS/TRS is assigned or configured will be referred to as CRS/DMRS/CSI-RS/SRS/UE-RS/TRS symbol/carrier/subcarrier/RE. For example, an OFDM symbol to or for which a tracking RS (TRS) is assigned or configured is referred to as a TRS symbol, a subcarrier to or for which the TRS is assigned or configured is referred to as a TRS subcarrier, and an RE to or for which the TRS is assigned or configured is referred to as a TRS RE. In addition, a subframe configured for transmission of the TRS is referred to as a TRS subframe. Moreover, a subframe in which a broadcast signal is transmitted is referred to as a broadcast subframe or a PBCH subframe and a subframe in which a synchronization signal (e.g. PSS and/or SSS) is transmitted is referred to a synchronization signal subframe or a PSS/SSS subframe. OFDM symbol/subcarrier/RE to or for which PSS/SSS is assigned or configured is referred to as PSS/SSS symbol/subcarrier/RE, respectively.

In the present invention, a CRS port, a UE-RS port, a CSI-RS port, and a TRS port refer to an antenna port configured to transmit a CRS, an antenna port configured to transmit a UE-RS, an antenna port configured to transmit a CSI-RS, and an antenna port configured to transmit a TRS, respectively. Antenna ports configured to transmit CRSs may be distinguished from each other by the locations of REs occupied by the CRSs according to CRS ports, antenna ports configured to transmit UE-RSs may be distinguished from each other by the locations of REs occupied by the UE-RSs according to UE-RS ports, and antenna ports configured to transmit CSI-RSs may be distinguished from each other by the locations of REs occupied by the CSI-RSs according to CSI-RS ports. Therefore, the term CRS/UE-RS/CSI-RS/TRS ports may also be used to indicate a pattern of REs occupied by CRSs/UE-RSs/CSI-RSs/TRSs in a predetermined resource region. In the present invention, both a DMRS and a UE-RS refer to RSs for demodulation and, therefore, the terms DMRS and UE-RS are used to refer to RSs for demodulation.

For the terms and techniques which are used herein but not specifically described, the 3GPP LTE/LTE-A standard documents, for example, 3GPP TS 36.211, 3GPP TS 36.212, 3GPP TS 36.213, 3GPP TS 36.321 and 3GPP TS 36.331, and the like may be referenced.

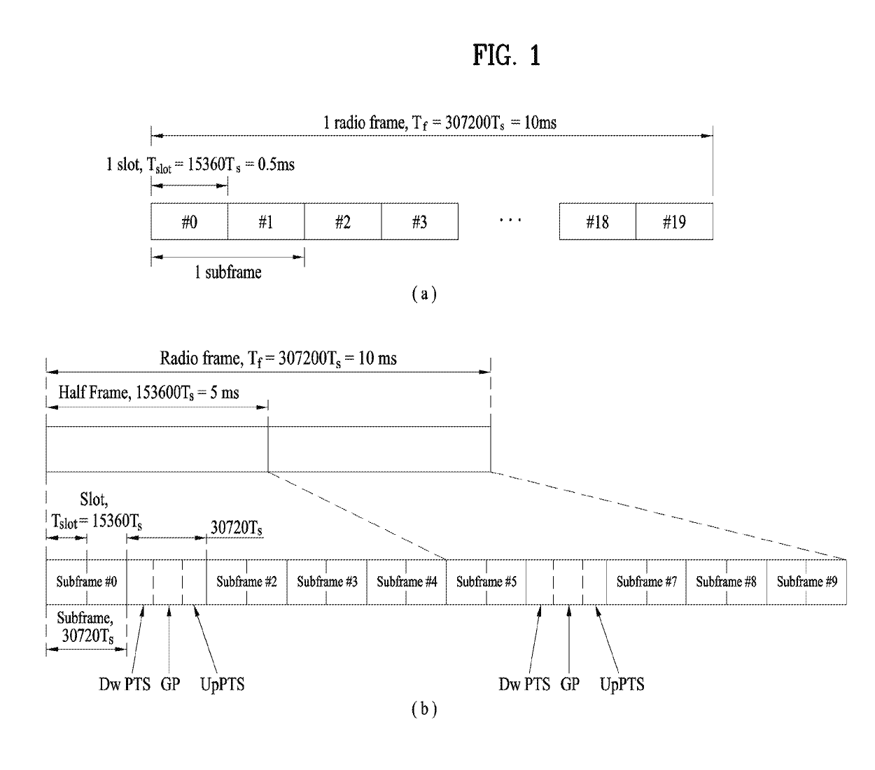

FIG. 1 illustrates the structure of a radio frame used in a LTE/LTE-A based wireless communication system.

Specifically, FIG. 1(a) illustrates an exemplary structure of a radio frame which can be used in frequency division multiplexing (FDD) in 3GPP LTE/LTE-A and FIG. 1(b) illustrates an exemplary structure of a radio frame which can be used in time division multiplexing (TDD) in 3GPP LTE/LTE-A.

Referring to FIG. 1, a 3GPP LTE/LTE-A radio frame is 10 ms (307,200Tₛ) in duration. The radio frame is divided into 10 subframes of equal size. Subframe numbers may be assigned to the 10 subframes within one radio frame, respectively. Here, Tₛ denotes sampling time where Tₛ=1/(2048*15 kHz). Each subframe is 1 ms long and is further divided into two slots. 20 slots are sequentially numbered from 0 to 19 in one radio frame. Duration of each slot is 0.5 ms. A time interval in which one subframe is transmitted is defined as a transmission time interval (TTI). Time resources may be distinguished by a radio frame number (or radio frame index), a subframe number (or subframe index), a slot number (or slot index), and the like.

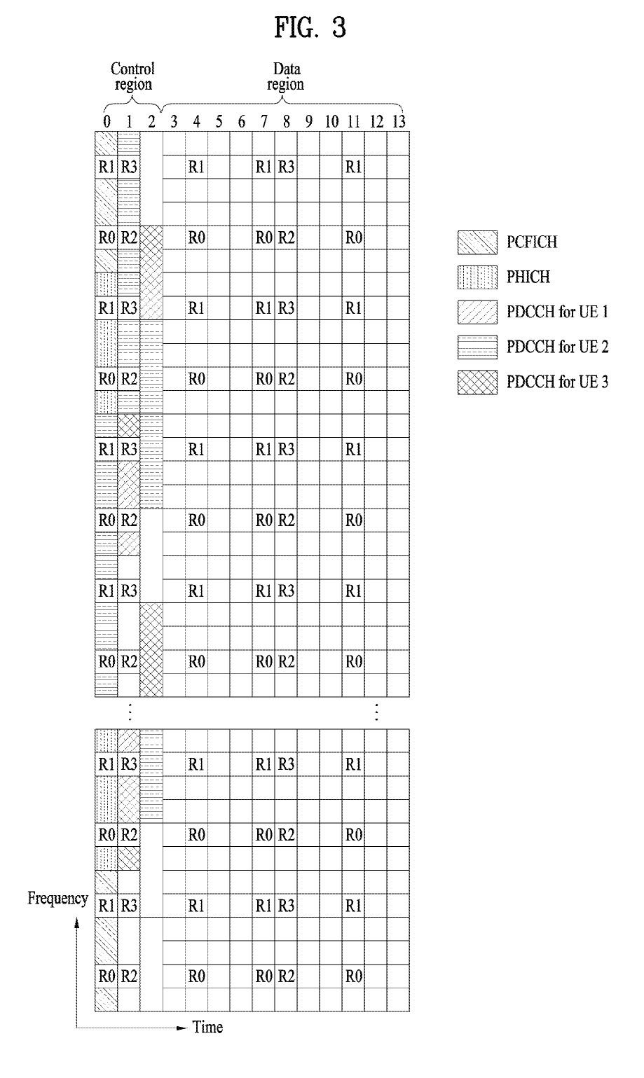

TTI refers to an interval during which data may be scheduled. For example, referring to FIGS. 1 and 3, in the current LTE/LTE-A system, a opportunity of transmission of an UL grant or a DL grant is present every 1 ms, and the UL/DL grant opportunity does not exists several times in less than 1 ms. Therefore, the TTI in the current LTE/LTE-A system is 1 ms.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

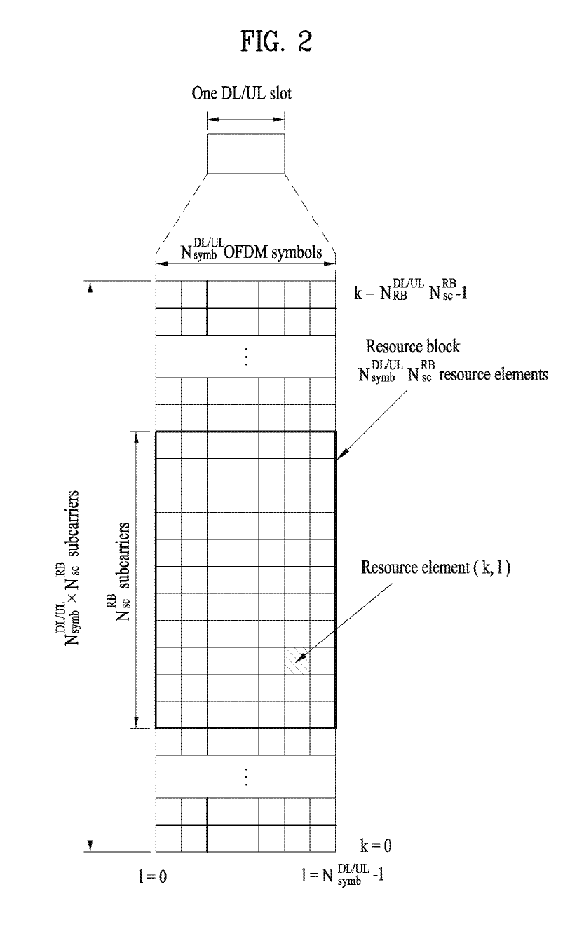

FIG. 2 illustrates the structure of a DL/UL slot structure in a LTE/LTE-A based wireless communication system.

Referring to FIG. 2, a slot includes a plurality of orthogonal frequency division multiplexing (OFDM) symbols in the time domain and includes a plurality of resource blocks (RBs) in the frequency domain. The OFDM symbol may refer to one symbol duration. Referring to FIG. 2, a signal transmitted in each slot may be expressed by a resource grid including N^{DL/UL}_{RB}*N^{RB}_{sc} subcarriers and N^{DL/UL}_{symb} OFDM symbols. N^{DL}_{RB} denotes the number of RBs in a DL slot and N^{UL}_{RB} denotes the number of RBs in a UL slot. N^{DL}_{RB} and N^{DL}_{RB} depend on a DL transmission bandwidth and a UL transmission bandwidth, respectively. N^{DL}_{symb} denotes the number of OFDM symbols in a DL slot, N^{UL}_{symb} denotes the number of OFDM symbols in a UL slot, and N^{RB}_{sc} denotes the number of subcarriers configuring one RB.

An OFDM symbol may be referred to as an OFDM symbol, a single carrier frequency division multiplexing (SC-FDM) symbol, etc. according to multiple access schemes. The number of OFDM symbols included in one slot may be varied according to channel bandwidths and CP lengths. For example, in a normal cyclic prefix (CP) case, one slot includes 7 OFDM symbols. In an extended CP case, one slot includes 6 OFDM symbols. Although one slot of a subframe including 7 OFDM symbols is shown in FIG. 2 for convenience of description, embodiments of the present invention are similarly applicable to subframes having a different number of OFDM symbols. Referring to FIG. 2, each OFDM symbol includes N^{DL/UL}_{RB}*N^{RB}_{sc} subcarriers in the frequency domain. The type of the subcarrier may be divided into a data subcarrier for data transmission, a reference signal (RS) subcarrier for RS transmission, and a null subcarrier for a guard band and a DC component. The null subcarrier for the DC component is unused and is mapped to a carrier frequency f₀ in a process of generating an OFDM signal or in a frequency up-conversion process. The carrier frequency is also called a center frequency f_{c}.

One RB is defined as N^{DL/UL}_{symb} (e.g. 7) consecutive OFDM symbols in the time domain and as N^{RB}_{sc} (e.g. 12) consecutive subcarriers in the frequency domain. For reference, a resource composed of one OFDM symbol and one subcarrier is referred to a resource element (RE) or tone. Accordingly, one RB includes N^{DL/UL}_{symb}*N^{RB}_{sc} REs. Each RE within a resource grid may be uniquely defined by an index pair (k, l) within one slot. k is an index ranging from 0 to N^{DL/UL}_{RB}*N^{RB}_{sc}−1 in the frequency domain, and l is an index ranging from 0 to N^{DL/UL}_{symb}−1 in the time domain.

Meanwhile, one RB is mapped to one physical resource block (PRB) and one virtual resource block (VRB). A PRB is defined as N^{DL}_{symb} (e.g. 7) consecutive OFDM or SC-FDM symbols in the time domain and N^{RB}_{sc} (e.g. 12) consecutive subcarriers in the frequency domain. Accordingly, one PRB is configured with N^{DL/UL}_{symb}*N^{RB}_{sc} REs. In one subframe, two RBs each located in two slots of the subframe while occupying the same N^{RB}_{sc} consecutive subcarriers are referred to as a physical resource block (PRB) pair. Two RBs configuring a PRB pair have the same PRB number (or the same PRB index).

FIG. 3 illustrates the structure of a DL subframe used in a LTE/LTE-A based wireless communication system.

Referring to FIG. 3, a DL subframe is divided into a control region and a data region in the time domain. Referring to FIG. 3, a maximum of 3 (or 4) OFDM symbols located in a front part of a first slot of a subframe corresponds to the control region. Hereinafter, a resource region for PDCCH transmission in a DL subframe is referred to as a PDCCH region. OFDM symbols other than the OFDM symbol(s) used in the control region correspond to the data region to which a physical downlink shared channel (PDSCH) is allocated. Hereinafter, a resource region available for PDSCH transmission in the DL subframe is referred to as a PDSCH region.

Examples of a DL control channel used in 3GPP LTE/LTE-A include a physical control format indicator channel (PCFICH), a physical downlink control channel (PDCCH), a physical hybrid ARQ indicator channel (PHICH), etc.

The PCFICH is transmitted in the first OFDM symbol of a subframe and carries information about the number of OFDM symbols available for transmission of a control channel within a subframe. The PCFICH carries a control format indicator (CFI), which indicates any one of values of 1 to 3. The PCFICH notifies the UE of the number of OFDM symbols used for the corresponding subframe every subframe. The PCFICH is located at the first OFDM symbol. The PCFICH is configured by four resource element groups (REGs), each of which is distributed within a control region on the basis of cell ID. One REG includes four REs.

The PHICH carries a HARQ (Hybrid Automatic Repeat Request) ACK/NACK (acknowledgment/negative-acknowledgment) signal as a response to UL transmission. The PHICH includes three REGs, and is scrambled cell-specifically. ACK/NACK is indicated by 1 bit, and the ACK/NACK of 1 bit is repeated three times. Each of the repeated ACK/NACK bits is spread with a spreading factor (SF) 4 or 2 and then mapped into a control region.

The control information transmitted through the PDCCH will be referred to as downlink control information (DCI). The DCI includes resource allocation information for a UE or UE group and other control information. Transmit format and resource allocation information of a downlink shared channel (DL-SCH) are referred to as DL scheduling information or DL grant. Transmit format and resource allocation information of an uplink shared channel (UL-SCH) are referred to as UL scheduling information or UL grant. The size and usage of the DCI carried by one PDCCH are varied depending on DCI formats. The size of the DCI may be varied depending on a coding rate. In the current 3GPP LTE system, various formats are defined, wherein formats 0 and 4 are defined for a UL, and formats 1, 1A, 1B, 1C, 1D, 2, 2A, 2B, 2C, 3 and 3A are defined for a DL. Combination selected from control information such as a hopping flag, RB allocation, modulation coding scheme (MCS), redundancy version (RV), new data indicator (NDI), transmit power control (TPC), cyclic shift, cyclic shift demodulation reference signal (DM RS), UL index, channel quality information (CQI) request, DL assignment index, HARQ process number, transmitted precoding matrix indicator (TPMI), precoding matrix indicator (PMI) information is transmitted to the UE as the DCI.

A plurality of PDCCHs may be transmitted within a control region. A UE may monitor the plurality of PDCCHs. An eNB determines a DCI format depending on the DCI to be transmitted to the UE, and attaches cyclic redundancy check (CRC) to the DCI. The CRC is masked (or scrambled) with an identifier (for example, a radio network temporary identifier (RNTI)) depending on usage of the PDCCH or owner of the PDCCH. For example, if the PDCCH is for a specific UE, the CRC may be masked with an identifier (for example, cell-RNTI (C-RNTI)) of the corresponding UE. If the PDCCH is for a paging message, the CRC may be masked with a paging identifier (for example, paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI). For example, CRC masking (or scrambling) includes XOR operation of CRC and RNTI at the bit level.

Generally, a DCI format, which may be transmitted to the UE, is varied depending on a transmission mode configured for the UE. In other words, certain DCI format(s) corresponding to the specific transmission mode not all DCI formats may only be used for the UE configured to a specific transmission mode. The UE may decode a PDSCH in accordance with DCI based on the DCI format successfully decoded. A transmission mode is semi-statically configured for the UE by the upper layer such that the UE may receive PDSCHs transmitted according to one of a plurality of predetermined transmission modes. The UE attempts to decode the PDCCH only in DCI formats corresponding to the transmission mode thereof. For example, tries to decode PDCCH candidates of a UE-specific search space (USS) to a fallback DCI (e.g., DCI format 1A), and tries to decode PDCCH candidates of a common search space (CSS) and the USS to a DCI format specific to a transmission mode with which the UE is configured. In other words, in order to maintain the computational load of the UE according to blind decoding attempts below a certain level, not all DCI formats are simultaneously searched by the UE.

The PDCCH is allocated to first m number of OFDM symbol(s) within a subframe. In this case, m is an integer equal to or greater than 1, and is indicated by the PCFICH.

The PDCCH is transmitted on an aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). For example, each CCE contains 9 REGs, which are distributed across the first 1/2/3 (/4 if needed for a 1.4 MHz channel) OFDM symbols and the system bandwidth through interleaving to enable diversity and to mitigate interference. One REG corresponds to four REs. Four QPSK symbols are mapped to each REG. A resource element (RE) occupied by the reference signal (RS) is not included in the REG. Accordingly, the number of REGs within given OFDM symbols is varied depending on the presence of the RS. The REGs are also used for other downlink control channels (that is, PDFICH and PHICH).

Assuming that the number of REGs not allocated to the PCFICH or the PHICH is N_{REG}, the number of available CCEs in a DL subframe for PDCCH(s) in a system is numbered from 0 to N_{CCE}−1, where N_{CCE}=floor(N_{REG}/9). The control region of each serving cell consists of a set of CCEs, numbered from 0 to N_{CCE,k}−1, where N_{CCE,k} is the total number of CCEs in the control region of subframe k. A PDCCH consisting of n consecutive CCEs may only start on a CCE fulfilling i mod n=0, where i is the CCE number.

A PDCCH format and the number of DCI bits are determined in accordance with the number of CCEs. The CCEs are numbered and consecutively used. To simplify the decoding process, a PDCCH having a format including n CCEs may be initiated only on CCEs assigned numbers corresponding to multiples of n. The number of CCEs used for transmission of a specific PDCCH is determined by a network or the eNB in accordance with channel status. For example, one CCE may be required for a PDCCH for a UE (for example, adjacent to eNB) having a good downlink channel. However, in case of a PDCCH for a UE (for example, located near the cell edge) having a poor channel, eight CCEs may be required to obtain sufficient robustness. Additionally, a power level of the PDCCH may be adjusted to correspond to a channel status.

In a 3GPP LTE/LTE-A system, a set of CCEs on which a PDCCH can be located for each UE is defined. A CCE set in which the UE can detect a PDCCH thereof is referred to as a PDCCH search space or simply as a search space (SS). An individual resource on which the PDCCH can be transmitted in the SS is called a PDCCH candidate. A set of PDCCH candidates that the UE is to monitor is defined in terms of SSs, where a search space S^{(L)}ₖ at aggregation level Lε{1, 2, 4, 8} is defined by a set of PDCCH candidates. SSs for respective PDCCH formats may have different sizes and a dedicated SS and a common SS are defined. The dedicated SS is a UE-specific SS (USS) and is configured for each individual UE. The common SS (CSS) is configured for a plurality of UEs.

The eNB transmits an actual PDCCH (DCI) on a PDCCH candidate in a search space and the UE monitors the search space to detect the PDCCH (DCI). Here, monitoring implies attempting to decode each PDCCH in the corresponding SS according to all monitored DCI formats. The UE may detect a PDCCH thereof by monitoring a plurality of PDCCHs. Basically, the UE does not know the location at which a PDCCH thereof is transmitted. Therefore, the UE attempts to decode all PDCCHs of the corresponding DCI format for each subframe until a PDCCH having an ID thereof is detected and this process is referred to as blind detection (or blind decoding (BD)).

For example, it is assumed that a specific PDCCH is CRC-masked with a radio network temporary identity (RNTI) ‘A’ and information about data transmitted using a radio resource ‘B’ (e.g. frequency location) and using transport format information ‘C’ (e.g. transmission block size, modulation scheme, coding information, etc.) is transmitted in a specific DL subframe. Then, the UE monitors the PDCCH using RNTI information thereof. The UE having the RNTI ‘A’ receives the PDCCH and receives the PDSCH indicated by ‘B’ and ‘C’ through information of the received PDCCH.

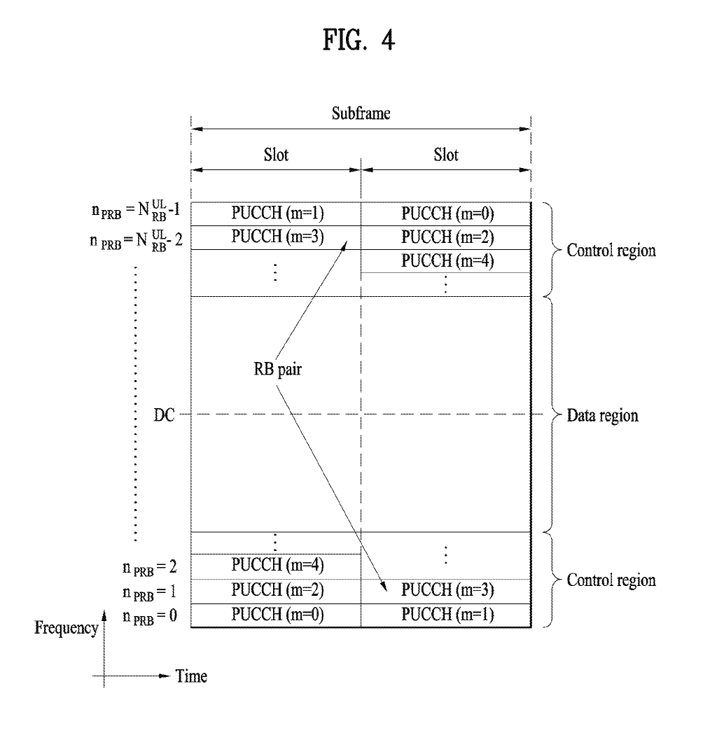

FIG. 4 illustrates the structure of a UL subframe used in a LTE/LTE-A based wireless communication system.

Referring to FIG. 4, a UL subframe may be divided into a data region and a control region in the frequency domain. One or several PUCCHs may be allocated to the control region to deliver UCI. One or several PUSCHs may be allocated to the data region of the UE subframe to carry user data.

In the UL subframe, subcarriers distant from a direct current (DC) subcarrier are used as the control region. In other words, subcarriers located at both ends of a UL transmission BW are allocated to transmit UCI. A DC subcarrier is a component unused for signal transmission and is mapped to a carrier frequency f₀ in a frequency up-conversion process. A PUCCH for one UE is allocated to an RB pair belonging to resources operating on one carrier frequency and RBs belonging to the RB pair occupy different subcarriers in two slots. The PUCCH allocated in this way is expressed by frequency hopping of the RB pair allocated to the PUCCH over a slot boundary. If frequency hopping is not applied, the RB pair occupies the same subcarriers.

The PUCCH may be used to transmit the following control information.
Scheduling request (SR): SR is information used to request a UL-SCH resource and is transmitted using an on-off keying (OOK) scheme.
HARQ-ACK: HARQ-ACK is a response to a PDCCH and/or a response to a DL data packet (e.g. a codeword) on a PDSCH. HARQ-ACK indicates whether the PDCCH or PDSCH has been successfully received. 1-bit HARQ-ACK is transmitted in response to a single DL codeword and 2-bit HARQ-ACK is transmitted in response to two DL codewords. A HARQ-ACK response includes a positive ACK (simply, ACK), negative ACK (NACK), discontinuous transmission (DTX), or NACK/DRX. HARQ-ACK is used interchangeably with HARQ ACK/NACK and ACK/NACK.
Channel state information (CSI): CSI is feedback information for a DL channel. CSI may include channel quality information (CQI), a precoding matrix indicator (PMI), a precoding type indicator, and/or a rank indicator (RI). In the CSI, MIMO-related feedback information includes the RI and the PMI. The RI indicates the number of streams or the number of layers that the UE can receive through the same time-frequency resource. The PMI is a value reflecting a space characteristic of a channel, indicating an index of a preferred precoding matrix for DL signal transmission based on a metric such as an SINR. The CQI is a value of channel strength, indicating a received SINR that can be obtained by the UE generally when the eNB uses the PMI.

Meanwhile, if RRH technology, cross-carrier scheduling technology, etc. are introduced, the amount of PDCCH which should be transmitted by the eNB is gradually increased. However, since a size of a control region within which the PDCCH may be transmitted is the same as before, PDCCH transmission acts as a bottleneck of system throughput. Although channel quality may be improved by the introduction of the aforementioned multi-node system, application of various communication schemes, etc., the introduction of a new control channel is required to apply the legacy communication scheme and the carrier aggregation technology to a multi-node environment. Due to the need, a configuration of a new control channel in a data region (hereinafter, referred to as PDSCH region) not the legacy control region (hereinafter, referred to as PDCCH region) has been discussed. Hereinafter, the new control channel will be referred to as an enhanced PDCCH (hereinafter, referred to as EPDCCH)

The EPDCCH may be configured within rear OFDM symbols starting from a configured OFDM symbol, instead of front OFDM symbols of a subframe. The EPDCCH may be configured using continuous frequency resources, or may be configured using discontinuous frequency resources for frequency diversity. By using the EPDCCH, control information per node may be transmitted to a UE, and a problem that a legacy PDCCH region may not be sufficient may be solved. For reference, the PDCCH may be transmitted through the same antenna port(s) as that(those) configured for transmission of a CRS, and a UE configured to decode the PDCCH may demodulate or decode the PDCCH by using the CRS. Unlike the PDCCH transmitted based on the CRS, the EPDCCH is transmitted based on the demodulation RS (hereinafter, DMRS). Accordingly, the UE decodes/demodulates the PDCCH based on the CRS and decodes/demodulates the EPDCCH based on the DMRS.

Recently, machine type communication (MTC) has come to the fore as a significant communication standard issue. MTC refers to exchange of information between a machine and an eNB without involving persons or with minimal human intervention. For example, MTC may be used for data communication for measurement/sensing/reporting such as meter reading, water level measurement, use of a surveillance camera, inventory reporting of a vending machine, etc. and may also be used for automatic application or firmware update processes for a plurality of UEs. In MTC, the amount of transmission data is small and UL/DL data transmission or reception (hereinafter, transmission/reception) occurs occasionally. In consideration of such properties of MTC, it would be better in terms of efficiency to reduce production cost and battery consumption of UEs for MTC (hereinafter, MTC UEs) according to data transmission rate. Since the MTC UE has low mobility, the channel environment thereof remains substantially the same. If an MTC UE is used for metering, reading of a meter, surveillance, and the like, the MTC UE is very likely to be located in a place such as a basement, a warehouse, and mountain regions which the coverage of a typical eNB does not reach. In consideration of the purposes of the MTC UE, it is better for a signal for the MTC UE to have wider coverage than the signal for the conventional UE (hereinafter, a legacy UE).

When considering the usage of the MTC UE, there is a high probability that the MTC UE requires a signal of wide coverage compared with the legacy UE. Therefore, if the eNB transmits a PDCCH, a PDSCH, etc. to the MTC UE using the same scheme as a scheme of transmitting the PDCCH, the PDSCH, etc. to the legacy UE, the MTC UE has difficulty in receiving the PDCCH, the PDSCH, etc. Therefore, the present invention proposes that the eNB apply a coverage enhancement scheme such as subframe repetition (repetition of a subframe with a signal) or subframe bundling upon transmission of a signal to the MTC UE having a coverage issue so that the MTC UE can effectively receive a signal transmitted by the eNB. For example, the PDCCH and PDSCH may be transmitted to the MTC UE having the coverage issue in a plurality of subframes (e.g. about 100 subframes).

As one method of reducing the cost of an MTC UE, the MTC UE may operate in, for example, a reduced DL and UL bandwidths of 1.4 MHz regardless of the system bandwidth when the cell operates. In this case, a sub-band (i.e., narrowband) in which the MTC UE operates may always be positioned at the center of a cell (e.g., 6 center PRBs), or multiple sub-bands for MTC may be provided in one subframe to multiplex MTC UEs in the subframe such that the UEs use different sub-bands or use the same sub-band which is not a sub-band consisting of the 6 center PRBs.

In this case, the MTC UE may not normally receive a legacy PDCCH transmitted through the entire system bandwidth, and therefore it may not be preferable to transmit a PDCCH for the MTC UE in an OFDM symbol region in which the legacy PDCCH is transmitted, due to an issue of multiplexing with a PDCCH transmitted for another UE. As one method to address this issue, introduction of a control channel transmitted in a sub-band in which MTC operates for the MTC UE is needed. As a DL control channel for such low-complexity MTC UE, a legacy EPDCCH may be used. Alternatively, an M-PDCCH, which is a variant of the legacy PDCCH/EPDCCH, may be introduced for the MTC UE.

A data channel (e.g., PDSCH, PUSCH) and/or control channel (e.g., M-PDCCH, PUCCH, PHICH) may be transmitted across multiple subframes to implement coverage enhancement (CE) of the UE, using a repetition technique or TTI bundling technique. On behalf of the CE, a control/data channel may be transmitted additionally using techniques such as cross-subframe channel estimation and frequency (narrowband) hopping. Herein, the cross-subframe channel estimation refers to a channel estimation technique using not only a reference signal in a subframe having a corresponding channel but also a reference signal in neighboring subframe(s).

The MTC UE may need CE up to, for example, 15 dB. However, not all MTC UEs are present in an environment which requires CE. In addition, the QoS requirements for MTC UEs are not identical. For example, devices such as a sensor and a meter have a low mobility and a small amount of data to transmit/receive and are very likely to be positioned in a shaded area. Accordingly, such devices may need high CE. On the other hand, wearable devices such as a smart watch may have mobility and are very likely to have a relatively large amount of data to transmit/receive and to be positioned in a place other than the shaded area. Accordingly, not all MTC UEs need a high level of CE, and the required capability may depend on the type of an MTC UE.

According to LTE-A Rel-13, CE may be divided into two modes. In a first mode (referred to as CE mode A), transmission may not be repeated or may be repeated only a few times. In a second mode (or CE mode B), many repetitions of transmission are allowed. A mode to enter between the two modes may be signaled to the MTC UE. Herein, parameters that a low-complexity/low-cost UE assumes for transmission/reception of a control channel/data channel may depend on the CE mode. In addition, the DCI format which the low-complexity/low-cost UE monitors may depend on the CE mode. Transmission of some physical channels may be repeated the same number of times regardless of whether the CE mode is CE mode A or CE mode B.

In the next system of LTE-A, a method to reduce latency of data transmission is considered. Packet data latency is one of the performance metrics that vendors, operators and also end-users (via speed test applications) regularly measure. Latency measurements are done in all phases of a radio access network system lifetime, when verifying a new software release or system component, when deploying a system and when the system is in commercial operation.

Better latency than previous generations of 3GPP RATs was one performance metric that guided the design of LTE. LTE is also now recognized by the end-users to be a system that provides faster access to internet and lower data latencies than previous generations of mobile radio technologies.

However, with respect to further improvements specifically targeting the delays in the system little has been done. Packet data latency is important not only for the perceived responsiveness of the system; it is also a parameter that indirectly influences the throughput. HTTP/TCP is the dominating application and transport layer protocol suite used on the internet today. According to HTTP Archive (http://httparchive.org/trends.php) the typical size of HTTP-based transactions over the internet are in the range from a few 10's of Kbytes up to 1 Mbyte. In this size range, the TCP slow start period is a significant part of the total transport period of the packet stream. During TCP slow start the performance is latency limited. Hence, improved latency can rather easily be shown to improve the average throughput, for this type of TCP-based data transactions. In addition, to achieve really high bit rates (in the range of Gbps), UE L2 buffers need to be dimensioned correspondingly. The longer the round trip time (RTT) is, the bigger the buffers need to be. The only way to reduce buffering requirements in the UE and eNB side is to reduce latency.

Radio resource efficiency could also be positively impacted by latency reductions. Lower packet data latency could increase the number of transmission attempts possible within a certain delay bound; hence higher block error ration (BLER) targets could be used for the data transmissions, freeing up radio resources but still keeping the same level of robustness for users in poor radio conditions. The increased number of possible transmissions within a certain delay bound, could also translate into more robust transmissions of real-time data streams (e.g. VoLTE), if keeping the same BLER target. This would improve the VoLTE voice system capacity.

There are more over a number of existing applications that would be positively impacted by reduced latency in terms of increased perceived quality of experience: examples are gaming, real-time applications like VoLTE/OTT VoIP and video telephony/conferencing.

Going into the future, there will be a number of new applications that will be more and more delay critical. Examples include remote control/driving of vehicles, augmented reality applications in e.g. smart glasses, or specific machine communications requiring low latency as well as critical communications.

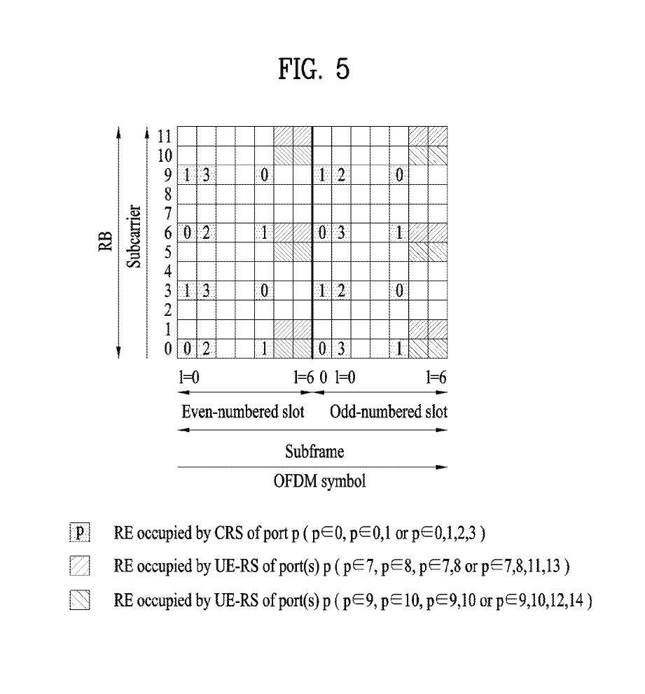

FIG. 5 illustrates configuration of cell specific reference signals (CRSs) and user specific reference signals (UE-RS).

In particular, FIG. 5 shows REs occupied by the CRS(s) and UE-RS(s) on an RB pair of a subframe having a normal CP.

In an existing 3GPP system, since CRSs are used for both demodulation and measurement, the CRSs are transmitted in all DL subframes in a cell supporting PDSCH transmission and are transmitted through all antenna ports configured at an eNB.

Referring to FIG. 5, the CRS is transmitted through antenna ports p=0, p=0, 1, p=0, 1, 2, 3 in accordance with the number of antenna ports of a transmission mode. The CRS is fixed to a certain pattern within a subframe regardless of a control region and a data region. The control channel is allocated to a resource of the control region, to which the CRS is not allocated, and the data channel is also allocated to a resource of the data region, to which the CRS is not allocated.

A UE may measure CSI using the CRSs and demodulate a signal received on a PDSCH in a subframe including the CRSs. That is, the eNB transmits the CRSs at predetermined locations in each RB of all RBs and the UE performs channel estimation based on the CRSs and detects the PDSCH. For example, the UE may measure a signal received on a CRS RE and detect a PDSCH signal from an RE to which the PDSCH is mapped using the measured signal and using the ratio of reception energy per CRS RE to reception energy per PDSCH mapped RE. However, when the PDSCH is transmitted based on the CRSs, since the eNB should transmit the CRSs in all RBs, unnecessary RS overhead occurs. To solve such a problem, in a 3GPP LTE-A system, a UE-specific RS (hereinafter, UE-RS) and a CSI-RS are further defined in addition to a CRS. The UE-RS is used for demodulation and the CSI-RS is used to derive CSI. The UE-RS is one type of DRS. Since the UE-RS and the CRS are used for demodulation, the UE-RS and the CRS may be regarded as demodulation RSs in terms of usage. Since the CSI-RS and the CRS are used for channel measurement or channel estimation, the CSI-RS and the CRS may be regarded as measurement RSs.

Referring to FIG. 5, UE-RSs are transmitted on antenna port(s) p=5, p=7, p=8 or p=7, 8, . . . , v+6 for PDSCH transmission, where v is the number of layers used for the PDSCH transmission. UE-RSs are present and are a valid reference for PDSCH demodulation only if the PDSCH transmission is associated with the corresponding antenna port. UE-RSs are transmitted only on RBs to which the corresponding PDSCH is mapped. That is, the UE-RSs are configured to be transmitted only on RB(s) to which a PDSCH is mapped in a subframe in which the PDSCH is scheduled unlike CRSs configured to be transmitted in every subframe irrespective of whether the PDSCH is present. Accordingly, overhead of the RS may be lowered compared to that of the CRS.

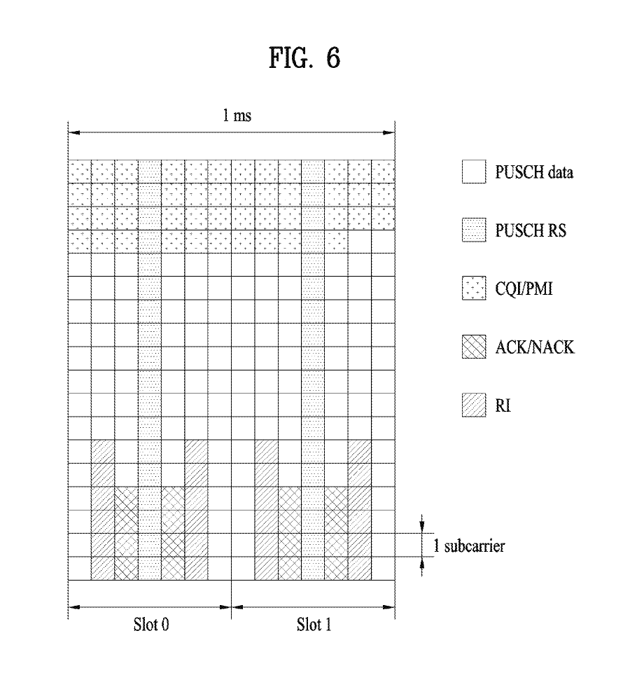

FIG. 6 illustrates multiplexing of uplink control information and uplink data in the PUSCH region.

Uplink data may be transmitted on the PUSCH in the data region of the UL subframe. A DM RS (Demodulation Reference Signal), which is a reference signal (RS) for demodulating the uplink data, may be transmitted together with uplink data in the data region of the UL subframe. Hereinafter, the control region and the data region in the UL subframe are referred to as a PUCCH region and a PUSCH region, respectively.

If uplink control information is to be transmitted in a subframe to which PUSCH transmission is allocated, the UE multiplexes the uplink control information (UCI) and the uplink data (hereinafter, PUSCH data) before DFT-spreading and transmits a multiplexed UL signal on the PUSCH unless simultaneous transmission of the PUSCH and the PUCCH is allowed. The UCI includes at least one of CQI/PMI, HARQ ACK/NACK, and RI. The number of REs used for each of CQI/PMI, ACK/NACK and RI transmissions is based on the Modulation and Coding Scheme (MCS) and offset values (Δ^{CQI}_{offset}, Δ^{HARQ-ACK}_{offset}, Δ^{RI}_{offset}) allocated for PUSCH transmission. The offset values allow different coding rates according to the UCI and are semi-statically configured by a higher layer (e.g., radio resource control (RRC)) signal. PUSCH data and UCI are not mapped to the same RE. The UCI is mapped to a subframe such that the UCI is arranged in both slots of the subframe.

Referring to FIG. 6, the CQI and/or PMI (CQI/PMI) resources are located at the beginning of the PUSCH data resource and sequentially mapped to all the SC-FDMA symbols on one subcarrier, and then mapped on the next subcarrier. The CQI/PMI is mapped in the subcarrier from left to right, i.e., in the direction of increasing the SC-FDMA symbol index. The PUSCH data is rate-matched considering the amount of CQI/PMI resources (i.e., the number of coded symbols). The same modulation order as that of the UL-SCH data is used for the CQI/PMI. The ACK/NACK is inserted into a part of the resources of SC-FDMA to which the UL-SCH data is mapped through puncturing. The ACK/NACK is located next to the PUSCH RS, which is the RS for demodulating the PUSCH data, and is arranged within the corresponding SC-FDMA symbol starting from the bottom and upward, i.e., in the direction of increasing subcarrier index. In the case of the normal CP, the SC-FDMA symbol for ACK/NACK is located on SC-FDMA symbols #2/#5 in each slot as shown in the figure. Regardless of whether ACK/NACK is actually transmitted in the subframe, the encoded RI is located next to the symbol for ACK/NACK.

In 3GPP LTE, the UCI may be scheduled to be transmitted on the PUSCH without PUSCH data. ACK/NACK, RI and CQI/PMI are multiplexed in a similar manner as shown in FIG. 6. Channel coding and rate matching for control signaling without PUSCH data are the same as in the case of control signaling with PUSCH data described above.

In FIG. 6, the PUSCH RS may be used in demodulating UCI and/or PUSCH data transmitted in the PUSCH region. In the present invention, the UL RS associated with PUCCH transmission and the UL RS associated with PUSCH transmission are referred to as PUCCH RS and PUSCH RS, respectively.

Although not shown, a sounding reference signal (SRS) may be allocated to the PUSCH region. The SRS is a UL reference signal not associated with transmission of the PUSCH or PUCCH, and is transmitted on the last OFDM symbol in the UL subframe in the time domain and in the data transmission band of the UL subframe in the frequency domain, i.e., in the PUSCH region. The eNB may measure the uplink channel state between the UE and the eNB using the SRS. SRSs of UEs transmitted/received on the last OFDM symbol of the same subframe may be classified according to frequency position/sequence.

Since the PUCCH RS, the PUSCH RS and SRS are UE-specifically generated and transmitted to the eNB by a specific UE, they may be regarded as uplink UE-specific RSs (hereinafter referred to as UL UE-RSs). The UL UE-RS is defined by a cyclic shift α of the basic sequence r_{u,v}(n) according to a predetermined rule. A plurality of basic sequences is defined for the PUCCH RS, PUSCH RS and SRS. For example, the basic sequences may be defined using a root Zadoff-Chu sequence. The basic sequences r_{u,v}(n) are divided into groups. Each basic sequence group includes one or more base sequences. The basic sequence for the UL UE-RS among the plurality of basic sequences is determined based on the cell identity and the slot index of the corresponding slot to which the UL UE-RS is mapped. The cell identity may be a physical layer cell identity obtained from a synchronization signal of the UE or a virtual cell identity provided by a higher layer signal. The cyclic shift value used for the cyclic shift of the basic sequences is determined based on the cell identity, the DCI and/or a cyclic shift related value given by a higher layer, the slot index of the corresponding slot to which the UL UE-RS is mapped.

FIG. 7 illustrates the length of a transmission time interval (TTI) which is needed to implement low latency.

Referring to FIG. 7, a propagation delay (PD), a buffering time, a decoding time, an A/N preparation time, an uplink PD, and an OTA (over the air) delay according to a retransmission margin are produced while a signal transmitted from the eNB reaches the UE, the UE transmits an A/N for the signal, and the A/N reaches the eNB. To satisfy low latency, a shortened TTI (sTTI) shorter than or equal to 0.5 ms needs to be designed by shortening the TTI, which is the smallest unit of data transmission. For example, to shorten the OTA delay, which is a time taken from the moment the eNB starts to transmit data (PDCCH and PDSCH) until the UE completes transmission of an A/N for the data to the eNB, to a time shorter than 1 ms, the TTI is preferably set to 0.21 ms. That is, to shorten the user plane (U-plane) delay to 1 ms, the sTTI may be set in the unit of about three OFDM symbols.

While FIG. 7 illustrates that the sTTI is configured with three OFDM symbols to satisfy 1 ms as the OTA delay or U-plane delay, an sTTI shorter than 1 ms may also be configured. For example, for the normal CP, an sTTI consisting of 2 OFDM symbols, an sTTI consisting of 4 OFDM symbols and/or an sTTI consisting of 7 OFDM symbols may be configured.

In the time domain, all OFDM symbols constituting a default TTI or the OFDM symbols except the OFDM symbols occupying the PDCCH region of the TTI may be divided into two or more sTTIs on some or all frequency resources in the frequency band of the default TTI, namely the channel band or system band of the TTI.

In the following description, a default TTI or main TTI used in the system is referred to as a TTI or subframe, and the TTI having a shorter length than the default/main TTI of the system is referred to as an sTTI. For example, in a system in which a TTI of 1 ms is used as the default TTI as in the current LTE/LTE-A system, a TTI shorter than 1 ms may be referred to as the sTTI. In addition, in the following description, a physical downlink control channel/physical downlink data channel/physical uplink control channel/physical uplink data channel transmitted in units of the default/main TTI are referred to as a PDCCH/PDSCH/PUCCH/PUSCH, and a PDCCH/PDSCH/PUCCH/PUSCH transmitted within an sTTI or in units of sTTI are referred to as sPDCCH/sPDSCH/sPUCCH/sPUSCH. In the new RAT environment, the numerology may be changed, and thus a default/main TTI different from that for the current LTE/LTE-A system may be used. However, for simplicity, the default/main TTI will be referred to as a TTI, subframe, legacy TTI or legacy subframe, and a TTI shorter than 1 ms will be referred to as an sTTI, on the assumption that the time length of the default/main TTI is 1 ms. The method of transmitting/receiving a signal in a TTI and an sTTI according to embodiments described below is applicable not only to the system according to the current LTE/LTE-A numerology but also to the default/main TTI and sTTI of the system according to the numerology for the new RAT environment.

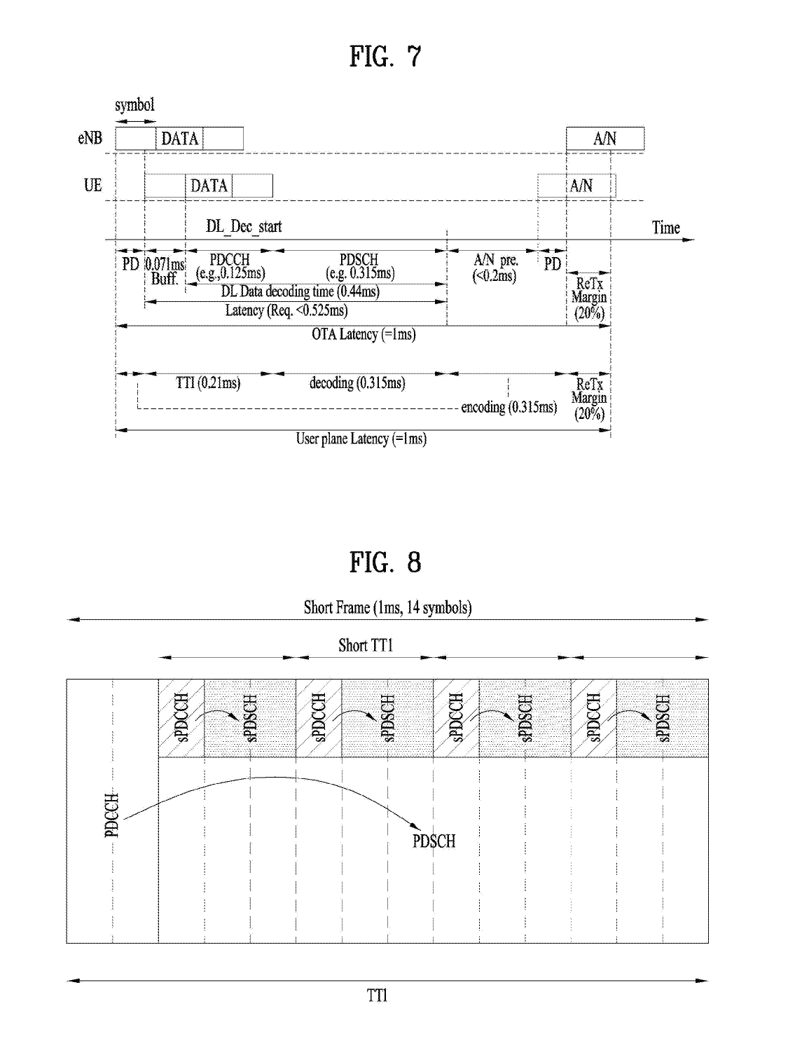

FIG. 8 illustrates an sTTI and transmission of a control channel and data channel within the sTTI.

In the downlink environment, a PDCCH for transmission/scheduling of data within an sTTI (i.e., sPDCCH) and a PDSCH transmitted within an sTTI (i.e., sPDSCH) may be transmitted. For example, referring to FIG. 8, a plurality of the sTTIs may be configured within one subframe, using different OFDM symbols. For example, the OFDM symbols in the subframe may be divided into one or more sTTIs in the time domain. OFDM symbols constituting an sTTI may be configured, excluding the leading OFDM symbols on which the legacy control channel is transmitted. Transmission of the sPDCCH and sPDSCH may be performed in a TDM manner within the sTTI, using different OFDM symbol regions. In an sTTI, the sPDCCH and sPDSCH may be transmitted in an FDM manner, using different regions of PRB(s)/frequency resources.

The present invention is directed to a method of providing a plurality of different services in one system by applying different system parameters according to the services or UEs to satisfy the requirements for the services. In particular, for a service/UE sensitive to latency, an sTTI may be used to send data in a short time and to allow a response to the data to be sent in a short time. Thereby, the latency may be reduced as much as possible. On the other hand, for a service/UE which is less sensitive to latency, a longer TTI may be used to transmit/receive data. For a service/UE which is sensitive to power efficiency rather than to latency, data may be repeatedly transmitted at the same low power or may be transmitted in units of a longer TTI. The present invention proposes a transmission method and multiplexing method for controlling information and data signals to enable the operations described above. The proposed methods are associated with the transmission aspect of a network, the reception aspect of a UE, multiplexing of multiple TTIs in one UE, and multiplexing of multiple TTIs between multiple UEs.

In contrast with the legacy LTE/LTE-A system, in which the length of a TTI is fixed to 1 ms, and thus all UEs and eNB perform signal transmission and reception in units of 1 ms, the present invention supports a system which has multiple TTI lengths, and one UE and one eNB may transmit and receive a signal using multiple TTI lengths. In particular, the present invention proposes a method of enabling the eNB and UE to communicate with each other while supporting various TTI lengths and variability when the TTI length is variable and a method of performing multiplexing for each channel and UE. While description of the present invention below is based on the legacy LTE-/LTE-A system, it is also applicable to systems other than the LTE/LTE-A system or RAT.

FIG. 9 illustrates an example of short TTIs configured in a legacy subframe.

In legacy LTE/LTE-A, if a subframe of 1 ms has a normal CP, the subframe consists of 14 OFDM symbols. If a TTI shorter than 1 ms is configured, a plurality of TTIs may be configured within one subframe. As shown in FIG. 9, each TTI may consist of, for example, 2 symbols, 3 symbols, 4 symbols, or 7 symbols. Although not shown in FIG. 9, a TTI consisting of one symbol may also be considered. If one symbol is one TTI unit, 12 TTIs may be configured in the default TTI of 1 ms, on the assumption that the legacy PDCCH is transmittable within two OFDM symbols. Similarly, when the two leading OFDM symbols are assumed to be the legacy PDCCH region, and two symbols are taken as one TTI unit, 6 TTIs may be configured within the default TTI. If three symbols are taken as one TTI, 4 TTIs may be configured within the default TTI. If 4 symbols are taken as one TTI unit, 3 TTIs may be configured within the default TTI.

If the 7 symbols are configured as one TTI, a TTI consisting of 7 leading symbols including the legacy PDCCH region and a TTI consisting of 7 subsequent symbols may be configured. In this case, if one TTI consists of 7 symbols, a UE supporting the short TTI assumes that the two leading OFDM symbols on which the legacy PDCCH is transmitted are punctured or rate-matched and the data and/or control signals of the UE are transmitted on the five subsequent symbols in the TTI (i.e., the TTI of the first slot) positioned at the leading part of one subframe (i.e., default TTI). On the other hand, the UE may assume that the data and/or control signals can be transmitted on all 7 symbols in a TTI positioned at the rear part of the same subframe (i.e., the TTI of the second slot) without any rate-matched or punctured resource region.

While FIG. 9 illustrates that the sTTIs configured in one subframe have the same length, sTTIs having different lengths may be configured in one subframe.

Embodiments of the present invention described below may be applied to a new radio access technology (RAT) system in addition to the 3GPP LTE/LTE-A system. As more and more communication devices demand larger communication capacity, there is a need for improved mobile broadband communication compared to existing RAT. Also, massive MTC, which provides various services by connecting many devices and objects, is one of the major issues to be considered in the next generation communication. In addition, a communication system design considering a service/UE sensitive to reliability and latency is being discussed. The introduction of next-generation RAT, which takes into account such advanced mobile broadband communication, massive MTC, and URLLC (Ultra-Reliable and Low Latency Communication), is being discussed. In the present invention, this technology is referred to as new RAT for simplicity.

<OFDM Numerology>

The new RAT system uses an OFDM transmission scheme or a similar transmission scheme. For example, the new RAT system may follow the OFDM parameters defined in the following table.

TABLE 1

| Parameter | Value | |
|---|---|---|
| Subcarrier-spacing (Δf) | 75 | kHz |
| OFDM symbol length | 13.33 | us |
| Cyclic Prefix(CP) length | 1.04 us/0/94 us | |
| System BW | 100 | MHz |
| No. of available subcarriers | 1200 | |
| Subframe length | 0.2 | ms |
| Number of OFDM symbol per | 14 | symbols |
| Subframe | | |

<Self-Contained Subframe Structure>

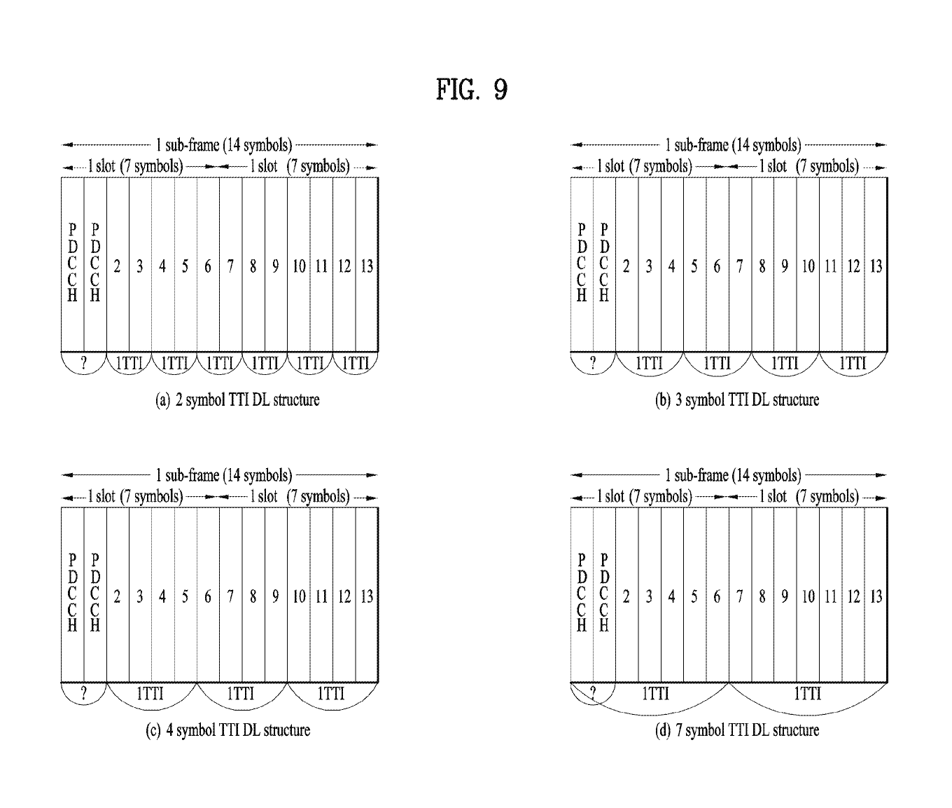

FIG. 10 illustrates a self-contained subframe structure.

In order to minimize the latency of data transmission in the TDD system, a self-contained subframe structure is considered in the new fifth-generation RAT.

In FIG. 10, the hatched area represents the transmission region of a DL control channel (e.g., PDCCH) carrying the DCI, and the black area represents the transmission region of a UL control channel (e.g., PUCCH) carrying the UCI. Here, the DCI is control information that the eNB transmits to the UE. The DCI may include information on cell configuration that the UE should know, DL specific information such as DL scheduling, and UL specific information such as UL grant. The UCI is control information that the UE transmits to the eNB. The UCI may include a HARQ ACK/NACK report on the DL data, a CSI report on the DL channel status, and a scheduling request (SR).

In FIG. 10, the region of symbols from symbol index 1 to symbol index 12 may be used for transmission of a physical channel (e.g., a PDSCH) carrying downlink data, or may be used for transmission of a physical channel (e.g., PUSCH) carrying uplink data. According to the self-contained subframe structure, DL transmission and UL transmission may be sequentially performed in one subframe, and thus transmission/reception of DL data and reception/transmission of UL ACK/NACK for the DL data may be performed in one subframe. As a result, the time taken to retransmit data when a data transmission error occurs may be reduced, thereby minimizing the latency of final data transmission.

In such a self-contained subframe structure, a time gap is needed for the process of switching from the transmission mode to the reception mode or from the reception mode to the transmission mode of the eNB and UE. On behalf of the process of switching between the transmission mode and the reception mode, some OFDM symbols at the time of switching from DL to UL in the self-contained subframe structure are set as a guard period (GP).

Referring to FIG. 10, a DL control channel on a wide band may be transmitted by time division multiplexing (TDM) with DL data or UL data. The eNB may transmit the DL control channel(s) over the entire band, but a UE may receive a DL control channel thereof in a specific band rather than the entire band. Here, the DL control channel refers to control information, which includes not only DL specific information such as DL scheduling but also information on cell configuration that the UE should know and UL specific information such as UL grant, transmitted from the eNB to the UE.

For example, a new RAT, referred to as mmWave and 5G, is expected to have a very large system bandwidth. Depending on the frequency band, 5 MHz, 10 MHz, 40 MHz, 80 MHz, etc. may have to be supported as minimum system bandwidth. The minimum system bandwidth may vary depending on the basic subcarrier spacing of the system. For example, when the basic subcarrier spacing is 15 kHz, the minimum system bandwidth is 5 MHz. When the basic subcarrier spacing is 30 kHz, the minimum system bandwidth is 10 MHz. When the basic subcarrier spacing is 120 kHz, the minimum system bandwidth is 40 MHz. When the basic subcarrier spacing is 240 kHz, the minimum system bandwidth may be 80 MHz. The new RAT is designed for sub-6 GHz and bands higher than or equal to 6 GHz and is also designed to support multiple subcarriers within a system to support various scenarios and use cases. When the subcarrier length is changed, the subframe length is also correspondingly reduced/increased. For example, one subframe may be defined as a short time such as 0.5 ms, 0.25 ms, or 0.125 ms. Higher frequency bands (e.g., higher than 6 GHz) may be used in the new RAT system, and a subcarrier spacing wider than the existing subcarrier spacing of 15 kHz in the legacy LTE system is expected to be supported. For example, when the subcarrier spacing is 60 kHz, one resource unit (RU) may be defined by 12 subcarriers on the frequency axis and one subframe on the time axis.

<Analog Beamforming>

In millimeter wave (mmW), the wavelength is shortened, and thus a plurality of antenna elements may be installed in the same area. For example, a total of 100 antenna elements may be installed in a 5-by-5 cm panel in a 30 GHz band with a wavelength of about 1 cm in a 2-dimensional array at intervals of 0.5λ (wavelength). Therefore, in mmW, increasing the coverage or the throughput by increasing the beamforming (BF) gain using multiple antenna elements is taken into consideration.

If a transceiver unit (TXRU) is provided for each antenna element to enable adjustment of transmit power and phase, independent beamforming is possible for each frequency resource. However, installing TXRU in all of the about 100 antenna elements is less feasible in terms of cost. Therefore, a method of mapping a plurality of antenna elements to one TXRU and adjusting the direction of a beam using an analog phase shifter is considered. This analog beamforming method may only make one beam direction in the whole band, and thus may not perform frequency selective beamforming (BF), which is disadvantageous.

Hybrid BF with B TXRUs that are fewer than Q antenna elements as an intermediate form of digital BF and analog BF may be considered. In the case of hybrid BF, the number of directions in which beams may be transmitted at the same time is limited to B or less, which depends on the method of collection of B TXRUs and Q antenna elements.

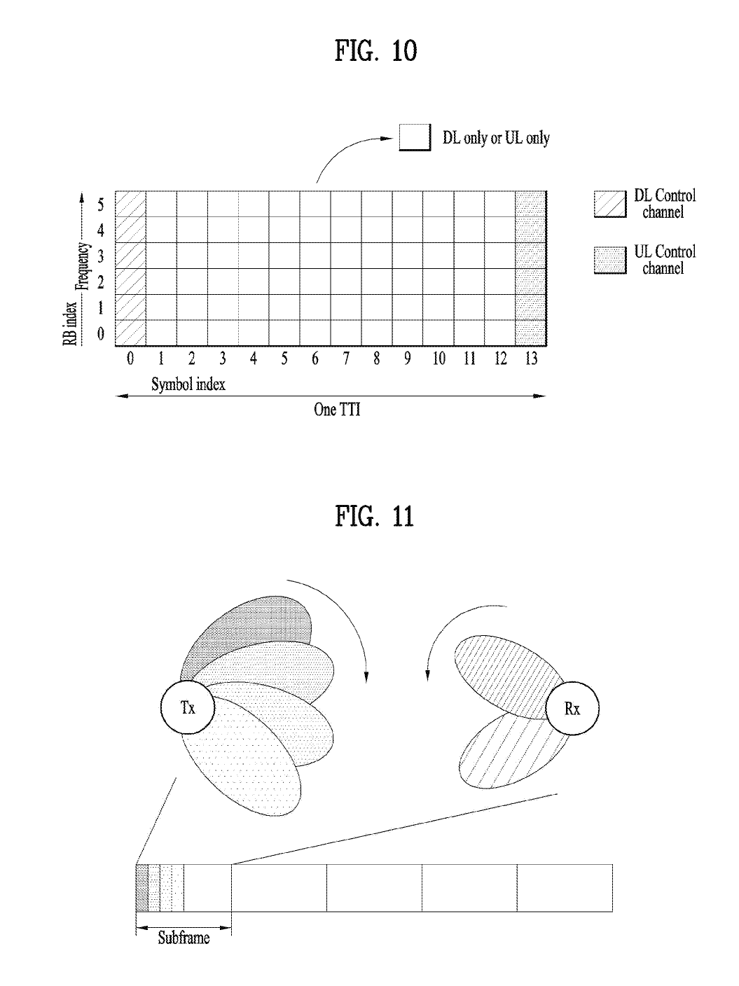

FIG. 11 illustrates an example of application of analog beamforming.

Referring to FIG. 11, a signal may be transmitted/received by changing the direction of a beam over time.

While a non-UE-specific signal (e.g., PSS/SSS/PBCH/SI) is transmitted omni-directionally in the LTE/LTE-A system, a scheme in which an eNB employing mmWave transmits a cell-common signal by omni-directionally changing the beam direction is considered. Transmitting/receiving signals by rotating the beam direction as described above is referred to as beam sweeping or beam scanning.

The present invention proposes a method of configuring a timing unit for scrambling, sPDCCH hashing, and DMRS sequence generation in a communication environment in which data transmission may be performed in short TTI units.

In an environment where a TTI length (e.g., shortened TTI) shorter than a typical TTI length (e.g., a subframe unit) is used for low latency, a scrambling sequence, a PDCCH hashing function, and a DMRS sequence which have been conventionally transmitted in units of subframes need to be changed.

Although the present invention will be described mainly focusing on the PDSCH as an example for simplicity, the present invention may be applied to other channels (e.g., PDSCH, (E)PDCCH, PUSCH, and PUCCH) in the same manner.

<A. Scrambling Sequence>

According to the current LTE/LTE-A specification, a scrambling sequence applied to PDSCH transmission is determined as follows.

For each codeword q, the block of bits b^{(q)}(0), . . . , b^{(q)} (M_{bit}^{(q)}−1), where M^{(q)}_{bit} is the number of bits in codeword q transmitted on the physical channel in one subframe, shall be scrambled prior to modulation, resulting in a block of scrambled bits \tilde{b}^{(q)}(0), . . . , \tilde{b}^{(q)}(M_{bit}^{(q)}−1) according to \tilde{b}^{(q)}(i)=(b^{(q)}(i)+c^{(q)}(i))mod 2, where the scrambling sequence c^{(q)}(i) is given by the pseudo-random sequence generation as follows. The pseudo-random sequences are defined defined by a length-31 Gold sequence. The output sequence c(n) of length M_{PN}, where n=0, 1, . . . , M_{PN}−1, is defined by the following equation.

c(n)=(x₁(n+N_{c})+x₂(n+N_{c}))mod 2

x₁(n+31)=(x₁(n+3)+x₁(n))mod 2

x₂(n+31)=(x₂(n+3)+x₂(n+2)+x₂(n+1)+x₂(n))mod 2 Equation 1

where N_{C}=1600 and the first m-sequence is initialized with x₁(0)=1, x₁(n)=0, n=1, 2, . . . , 30. The initialization of the second m-sequence is denoted by cᵢₙᵢₜ=Σᵢ₌₀³⁰x₂(i)·2ⁱ with the value depending on the application of the sequence. The scrambling sequence generator for PDSCH shall be initialized at the start of each subframe, where the initialization value of cᵢₙᵢₜ depends on the transport channel type according to the following equation

$${c}_{init} = \{ \begin{matrix}{n}_{RNTI} \cdot {2}^{14} + q \cdot {2}^{13} + ⌊ {n}_{s} \text{/} 2 ⌋ \cdot {2}^{9} + {N}_{ID}^{cell} & for PDSCH \\ ⌊ {n}_{s} \text{/} 2 ⌋ \cdot {2}^{9} + {N}_{ID}^{MBSFN} & for PMCH\end{matrix} \qquad Equation 2$$

where n_{RNTI} corresponds to the RNTI associated with the PDSCH transmission as described in clause 7.1 of 3GPP TS 36.213. Up to two codewords can be transmitted in one subframe, i.e., qε{0, 1}. In the case of single codeword transmission, q is equal to zero.

As can be seen from Equation 2, the scrambling sequence depends on └nₛ/2┘=subframe index. According to the current LTE/LTE-A specification, the scrambling sequence associated with other channels (e.g., PDSCH, (E)PDCCH, PUSCH, PUCCH) also depends on the subframe index.

In the present invention, it is proposed that a scrambling sequence be generated differently according to the sTTI index rather than the subframe index in order to transmit a control/data channel to be transmitted in an sTTI (UL or DL). According to the proposal, an interference randomization effect may be better obtained in an environment where data is transmitted/received in units of sTTI. The sTTI index may be defined, for example, as 1) an sTTI index within one subframe index. In this case, for example, if there are four sTTIs in the subframe, there may be four different sTTI indexes. In this case, however, indexes may not be distinguished between sTTIs existing at the same position in different subframes. To address this issue, 2) the sTTI index may be defined as an sTTI index in a radio frame. In this case, for example, if there are four sTTIs in a subframe, for example, a total of 40 sTTI indexes may be present in a radio frame consisting of 10 subframes. Alternatively, 3) the sTTI index may be defined as an sTTI index within four radio frames. In this case, for example, if there are four sTTIs in a subframe, a total of 160 sTTI indexes distinguished from each other may be present in, for example, four radio frames consisting of 40 subframes.

<B. sPDCCH Hashing Function>

According to the current LTE/LTE-A specification, the hashing function applied to transmission of the PDCCH is determined as follows.

The set of PDCCH candidates to monitor are defined in terms of search spaces, where a search space S^{(L)}ₖ at aggregation level Lε{1, 2, 4, 8} is defined by a set of PDCCH candidates. For each serving cell on which PDCCH is monitored, the CCEs corresponding to PDCCH candidate m of the search space S^{(L)}ₖ are given by L{(Yₖ+m′) mod └N_{CCE,k}/L┘}+i, where Yₖ is defined below, i=0, . . . , L−1. For the common search space m′=m. For the PDCCH UE specific search space, for the serving cell on which PDCCH is monitored, if the monitoring UE is configured with carrier indicator field then m′=m+M^{(L)}*n_{CI}, where n_{CI} is the carrier indicator field value, else if the monitoring UE is not configured with carrier indicator field then m′=m, where m=M^{(L)}−1. M^{(L)} is the number of PDCCH candidates to monitor in the given search space. For the common search spaces, Yₖ is set to 0 for the two aggregation levels L=4 and L=8. For the UE-specific search space S^{(L)}ₖ at aggregation level L, the variable Yₖ is defined by Yₖ=(A*Yₖ₋₁)mod D, where Y₋₁=n_{RNTI}≠0, A=39827, D=65537 and k=└nₛ/2┘, nₛ is the slot number within a radio frame. The RNTI value used for n_{RNTI} is defined in subclause 7.1 of 3GPP TS 36.213 in downlink and subclause 8 of 3GPP TS 36.213 in uplink.

That is, the hashing value Yₖ varies depending on └nₛ/2┘=subframe index. According to the current LTE/LTE-A specification, the hashing value associated with the EPDCCH also depends on the subframe index.

In the present invention, it is proposed that, in order to transmit the sPDCCH, which is transmitted in the sTTI, the hashing value Yₖ is generated differently according to the sTTI index rather than the subframe index. This makes it possible to obtain a better interference randomization effect between different UEs in the environment where the sPDCCH is transmitted in units of sTTI. The sTTI index may be defined, for example, as 1) an sTTI index within one subframe index. In this case, for example, if there are four sTTIs in the subframe, there may be four different sTTI indexes. In this case, however, indexes may not be distinguished between sTTIs existing at the same position in different subframes. To address this issue, 2) the sTTI index may be defined as an sTTI index in a radio frame. In this case, for example, if there are four sTTIs in a subframe, for example, a total of 40 sTTI indexes may be present in a radio frame consisting of 10 subframes. Alternatively, 3) the sTTI index may be defined as an sTTI index within four radio frames. In this case, for example, if there are four sTTIs in a subframe, a total of 160 sTTI indexes distinguished from each other may be present in, for example, four radio frames consisting of 40 subframes.

<C. Downlink DMRS Sequence Generation>

According to the current LTE/LTE-A specification, the DMRS (UE-specific RS) sequence associated with the PDSCH is determined as follows.

For antenna port 5, the UE-specific reference-signal (UE-RS) sequence rₙ_{ₛ}(m) is defined by the following equation:

rₙ_{ₛ}(m)=1/\sqrt{2}(1−2·c(2m))+j1/\sqrt{2}(1−2·c(2m+1)), m=0, 1, . . . , 12N_{RB}^{PDSCH}−1, Equation 3

where N^{PDSCH}_{RB} denotes the assigned bandwidth in resource blocks of the corresponding PDSCH transmission. The pseudo-random sequence c(i) is defined in the above-stated pseudo-random sequence generation. The pseudo-random sequence generator shall be initialized with the following equation at the start of each subframe:

cᵢₙᵢₜ=(└nₛ/2┘+1)·(2N_{ID}^{cell}+1)·2¹⁶+n_{RNTI} Equation 4

where n_{RNTI} is as described in clause 7.1 of 3GPP TS 36.213.

For any of the antenna ports pε{7, 8, . . . , v+6}, the UE-RS sequence r(m) is defined by the following equation:

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} , \qquad Equation 5$$

where the pseudo-random sequence c(i) is defined in the above-stated pseudo-random sequence generation. The pseudo-random sequence generator shall be initialized with the following equation at the start of each subframe:

cᵢₙᵢₜ=(└nₛ/2┘+1)·(2n_{ID}⁽ⁿ^{_{SCID}}⁾+1)·2¹⁶+n_{SCID} Equation 6

where the quantities n(i)_{ID}), i=0, 1, which is corresponding to n^{(nSCID)}_{ID}, are given by a physical layer cell identity N^{cell}_{ID} if no value for a scrambling identity n^{DMRS,i}_{ID} is provided by higher layers or if DCI format 1A, 2B or 2C is used for DCI format associated with the PDSCH transmission, and given by n^{DMRS,i}_{ID} otherwise. The value of n_{SCID} is zero unless specified otherwise. For a PDSCH transmission on antenna ports 7 or 8, n_{sCID} is given by the DCI format 2B or 2C. DCI format 2B is a DCI format for resource assignment for a PDSCH using a maximum of two antenna ports having UE-RSs. DCI format 2C is a DCI format for resource assignment for a PDSCH using a maximum of 8 antenna ports having UE-RSs.

As can be seen from Equation 4 and Equation 6, the UE-RS sequence varies depending on └nₛ/2┘=subframe index. According to the current LTE/LTE-A specification, the UE-RS sequence associated with EPDCCH also depends on └nₛ/2┘=subframe index.

In the present invention, in order to generate a UE-RS sequence associated with a PDSCH and (E)PDCCH (sPDCCH) transmitted in an sTTI, it is proposed that the UE-RS sequence be generated differently according to the sTTI index instead of the subframe index. This makes it possible to obtain a better interference randomization effect in the environment where data is transmitted and received in units of sTTI. The sTTI index may be defined, for example, as 1) an sTTI index within one subframe index. In this case, for example, if there are four sTTIs in the subframe, there may be four different sTTI indexes. In this case, however, indexes may not be distinguished between sTTIs existing at the same position in different subframes. To address this issue, 2) the sTTI index may be defined as an sTTI index in a radio frame. In this case, for example, if there are four sTTIs in a subframe, for example, a total of 40 sTTI indexes may be present in a radio frame consisting of 10 subframes. Alternatively, 3) the sTTI index may be defined as an sTTI index within four radio frames. In this case, for example, if there are four sTTIs in a subframe, a total of 160 sTTI indexes distinguished from each other may be present in, for example, four radio frames consisting of 40 subframes.

<D. Uplink DMRS Sequence Generation>

According to the current LTE/LTE-A specification, the DMRS sequence associated with the PUSCH is determined as follows.

The PUSCH demodulation reference signal sequence r_{PUSCH}^{(λ)}(•) associated with layer λε{0, 1, . . . , v−1} is defined by the following equation:

r_{PUSCH}^{(λ)}(m·M_{sc}^{RS}+n)=w^{(λ)}(m)r_{u,v}^{(α}^{_{λ}}⁾(n) Equation 7

where m=0, 1, n=0, . . . , M^{RS}_{sc}−1, and M^{RS}_{sc}=M^{PUSCH}_{sc}.

Subclause 5.5.1 of 3GPP TS 36.211 defines the sequence r_{u,v}^{(α}^{_{λ}}⁾(0), . . . , r_{u,v}^{(α}^{_{λ}}⁾(M_{sc}^{RS}−1. The orthogonal sequence w^{(λ)}(m) is given by [w^{λ}(0) w^{λ}(1)]=[1 1] for DCI format 0 if the higher-layer parameter Activate-DMRS-with OCC is not set or if the temporary C-RNTI was used to transmit the most recent uplink-related DCI for the transport block associated with the corresponding PUSCH transmission, otherwise it is given by Table 2 using the cyclic shift field in most recent uplink-related DCI (refer to 3GPP TS 36.212) for the transport block associated with the corresponding PUSCH transmission.

TABLE 2

| Cyclic Shift Field in uplink- | n_{DMRS, λ}⁽²⁾ | | | | [w^{(λ)}(0) w^{(λ)}(1)] | | | |
|---|---|---|---|---|---|---|---|---|
| related DCI format | λ = 0 | λ = 1 | λ = 2 | λ = 3 | λ = 0 | λ = 1 | λ = 2 | λ = 3 |
| 000 | 0 | 6 | 3 | 9 | [1 1] | [1 1] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

The cyclic shift α_{λ} in a slot nₛ is given as λ_{λ}=2πn_{cs,λ}/12 with the following equation:

n_{cs,λ}(n_{DMRS}⁽¹⁾+n_{DMRS,λ}⁽²⁾+n_{PN}(nₛ))mod 12, Equation 8

where the values of n_{DMRS}⁽¹⁾ is given by Table 3 according to the parameter cyclicShift provided by higher layers, n_{DMRS,λ}⁽²⁾ is given by the cyclic shift for DMRS field in most recent uplink-related DCI for the transport block associated with the corresponding PUSCH transmission where the value of n_{DMRS,λ}⁽²⁾ is given in Table 2.

TABLE 3

| cyclicShift | n_{DMRS}⁽¹⁾ |
|---|---|
| 0 | 0 |
| 1 | 2 |
| 2 | 3 |
| 3 | 4 |
| 4 | 6 |
| 5 | 8 |
| 6 | 9 |
| 7 | 10 |

The first row of Table 2 shall be used to obtain n_{DMRS,0}⁽²⁾ and w^{(λ)}(m) if there is no uplink-related DCI for the same transport block associated with the corresponding PUSCH transmission, and if the initial PUSCH for the same transport block is semi-persistently scheduled, or if the initial PUSCH for the same transport block is scheduled by the random access response grant. The quantity n_{PN} (nₛ) is given by the following equation:

n_{PN}(nₛ)=Σᵢ₌₀⁷c(8N_{symb}^{UL}·nₛ+i)·2ⁱ, Equation 9

where the pseudo-random sequence c(i) is defined by the above-stated pseudo-random sequence generation. The application of c(i) is cell-specific. The pseudo-random sequence generator shall be initialized with cᵢₙᵢₜ at the beginning of each radio frame. The quantity cᵢₙᵢₜ is given by

$${c}_{init} = ⌊ \frac{{N}_{ID}^{cell}}{30} ⌋ \cdot {2}^{5} + ( ( {N}_{ID}^{cell} + {Δ}_{ss} ) mod 30 )$$

if no value for N_{ID}^{csh}^{_}^{DMRS} is configured by higher layers or the PUSCH transmission corresponds to a Random Access Response Grant or a retransmission of the same transport block as part of the contention based random access procedure, otherwise it is given by

$${c}_{init} = ⌊ \frac{{N}_{ID}^{csh\_DMRS}}{30} ⌋ \cdot {2}^{5} + ( {N}_{ID}^{csh\_DMRS} mod 30 ) .$$

As can be seen from Equation 8 or Equation 9, the DMRS sequence varies depending on nₛ=slot index.

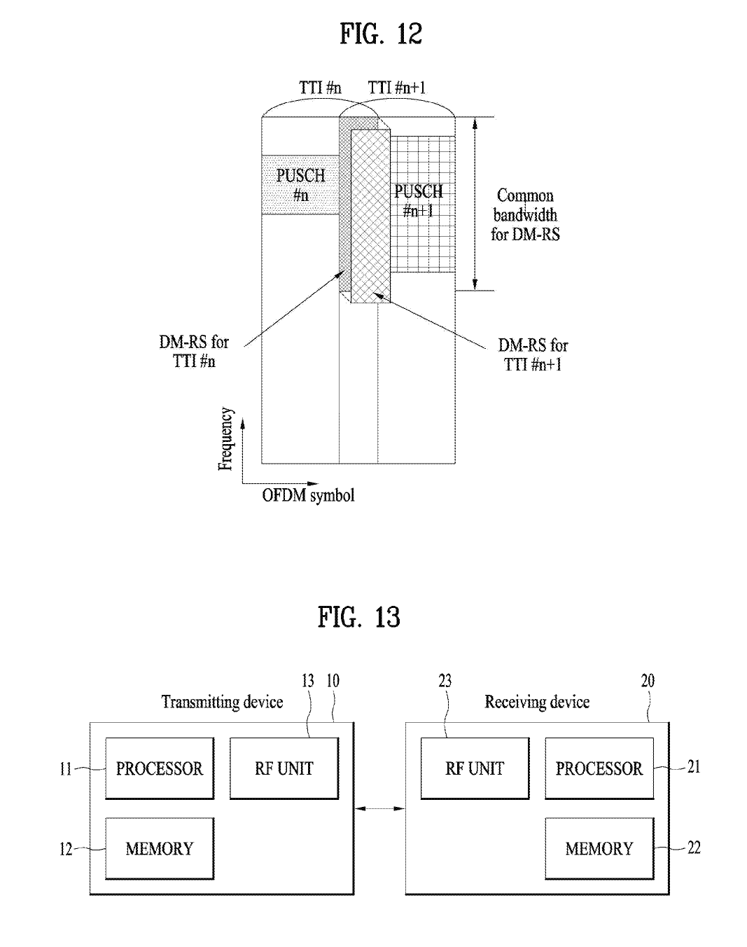

FIG. 12 illustrates an uplink demodulation reference signal according to an embodiment of the present invention.

In the case of the PUSCH transmitted in the sTTI, the technique of demodulation reference signal (DMRS) symbol sharing may be applied. DMRS symbol sharing refers to transmitting PUSCH DMRSs by sharing the same DMRS resource position or the same OFDM symbol position for PUSCHs respectively transmitted in two (or two or more) consecutive sTTIs, as illustrated in FIG. 12. Referring to FIG. 12, a DM-RS for PUSCH #n transmitted in TTI #n and a DM-RS for PUSCH # n+1 transmitted in TTI # n+1 may be transmitted in the same 01-DM symbol. For example, DM-RSs for two adjacent TTIs are transmitted in the same symbol. In this case, a DM-RS transmission resource other than the resource allocation for the PUSCH transmission may be allocated to the UE, and the UE may transmit the PUSCH and the DM-RS on different corresponding UL resources. More generally, a DM-RS transmission resource separate from resource allocation for PUSCH transmission may be configured for each TTI while a DM-RS for a plurality of TTIs is transmitted on the same SC-FDMA symbol. Thereby, the UE may transmit the PUSCH and the DM-RS using different configured UL resources. That is, according to the legacy LTE/LTE-A specification, the frequency resource occupied by the DM-RS for the PUSCH matches the frequency resource occupied by the PUSCH. On the other hand, according to the present invention, the frequency resources on which the PUSCH is transmitted may not match the DM-RS resources for the PUSCH, as shown in FIG. 12. For example, according to the legacy LTE/LTE-A specification, if the PUSCH is mapped over specific frequency resources, the corresponding DM-RS is also mapped over the specific frequency resources. On the other hand, according to the present invention, the range of frequency resources to which the PUSCH is mapped may be different from the range of frequency resources to which the DM-RS is mapped.

In the present invention, it is proposed that the following methods be used to generate a DMRS sequence associated with the PUSCH transmitted in an sTTI.

Method 1) The present invention proposes that the DMRS sequence be generated differently according to the sTTI index of the sTTI in which the DMRS sequence is transmitted (or the PUSCH associated with the DMRS is transmitted). For example, in the equation for generation of a DMRS sequence, nₛ=slot index may be replaced with sTTI index. Method 1 may be more appropriate in terms of DM-RS resource overhead in the case where PUSCH DMRSs are transmitted at distinguished resource positions or distinguished OFDM symbol positions according to sTTIs.

Method 2) Considering the case where the DMRS symbol sharing technique is applied, the present invention proposes that the DMRS sequence be generated differently according to the sTTI index of the previous sTTI among the two sTTIs in which DMRS symbol sharing is performed. For example, when the PUSCH DMRS is transmitted using the same OFDM symbol resource in sTTI #n and sTTI #n+1, the DMRS sequences associated with the PUSCH transmitted in the two sTTIs may be generated using the sTTI index of sTTI #n. Alternatively, a DMRS sequence may be generated according to the sTTI index of the latter one (sTTI #n+1) of the two sTTIs in which DMRS symbol sharing is performed. According to the legacy LTE/LTE-A specification, the DMRS sequence depends on the slot index where the DM-RS is located. On the other hand, according to Method 2, when two sTTIs share a DM-RS time symbol, the DM-RS sequence transmitted on the time symbol does not necessarily depend on the slot index at which the DM-RS sequence is located. According to the present invention, the same DM-RS sequence is generated despite DM-RSs for PUSCHs transmitted in different sTTIs. The DM-RS for sTTI #n and the DM-RS for sTTI #n+1 may be distinguished by applying different orthogonal sequences and different cyclic shift values to the DM-RS sequences, respectively.

Method 3) In a more general manner, the present invention proposes that a DMRS sequence be generated differently according to └STTI index/2┘ or ┌sTTI index/2┐ of the sTTI in which the DMRS sequence is transmitted (or the PUSCH associated with the DMRS is transmitted). The “sTTI index” └sTTI index/2┘ or ┌sTTI index/2┐ may be an index of one sTTI. Alternatively, the “sTTI index” may refer to the sum of the sTTI indexes when there are multiple sTTI indexes at which the DMRS sequence is transmitted or the PUSCH associated with the DMRS is transmitted. For example, referring to FIG. 12, when the time symbol with the DMRS belongs to the sTTI #n and also belongs to the sTTI #n+1, the sum of the index of the sTTI #n and the index of the sTTI # n+1 may be used as an sTTI index at └sTTI index/2┘ or ┌sTTI index/2┐.

Since PUSCH transmission is scheduled by the eNB, the eNB knows the sTTI and the frequency resource through which PUSCH is received. In addition, the eNB according to the present invention may know a TTI index forming the basis of generation of a DMRS to be transmitted for the corresponding PUSCH. Thus, the eNB may receive or detect the PUSCH(s) and the corresponding DMRS(s) in the sTTI(s) according to the present invention. The eNB may detect/decode/acquire the DMRS(s) for the PUSCH(s) using the sTTI index according to the present invention. The eNB may demodulate the corresponding PUSCH based on the acquired DMRS.

In Method 1, Method 2, and Method 3, the sTTI index may be defined, for example, as 1) an sTTI index within one subframe index. In this case, for example, if there are four sTTIs in the subframe, there may be four different sTTI indexes. In this case, however, indexes may not be distinguished between sTTIs existing at the same position in different subframes. To address this issue, 2) the sTTI index may be defined as an sTTI index in a radio frame. In this case, for example, if there are four sTTIs in a subframe, a total of 40 sTTI indexes, for example, may be present in a radio frame consisting of 10 subframes. Alternatively, 3) the sTTI index may be defined as an sTTI index within four radio frames. In this case, for example, if there are four sTTIs in a subframe, a total of 160 sTTI indexes distinguished from each other may be present in, for example, four radio frames consisting of 40 subframes.

FIG. 13 is a block diagram illustrating elements of a transmitting device 10 and a receiving device 20 for implementing the present invention.

The transmitting device 10 and the receiving device 20 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 20 is the reverse of the signal processing process of the transmitting device 10. Under control of the processor 21, the RF unit 23 of the receiving device 20 receives radio signals transmitted by the transmitting device 10. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 10 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 20. An RS transmitted through a corresponding antenna defines an antenna from the view point of the receiving device 20 and enables the receiving device 20 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 10 in UL and as the receiving device 20 in DL. In the embodiments of the present invention, an eNB operates as the receiving device 20 in UL and as the transmitting device 10 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

The eNB processor may generate a scrambling sequence based on the sTTI index in accordance with the present invention. The eNB processor may scramble downlink information using the scrambling sequence. The eNB processor may control the eNB RF unit to transmit the scrambled downlink information in a corresponding sTTI for carrying the scrambled downlink information. The UE processor may control the UE RF unit to receive the downlink signal on a downlink channel in an sTTI. The UE processor may descramble the downlink signal using a scrambling sequence obtained based on the sTTI index of the sTTI.

The eNB processor may determine the value of the hash function based on the sTTI index according to the present invention. The eNB processor may control the eNB RF unit to transmit a downlink control channel in a search space determined based on the value of the hashing function. The UE processor may recognize the search space to be monitored in the corresponding sTTI based on the hashing function value determined based on the sTTI index. The UE processor may attempt to detect the downlink control channel in the search space within the sTTI.

The eNB processor may generate a DMRS for the downlink channel based on the sTTI index according to the present invention. The eNB processor may control the eNB RF unit to transmit the downlink channel and the DMRS within the corresponding sTTI. The UE RF unit may receive the downlink channel and the DMRS for the downlink channel within the sTTI. The UE processor may detect/acquire the DMRS from the signals received within the sTTI, based on the sTTI index. The UE processor may demodulate the downlink channel based on the DMRS.

The eNB processor may allocate/schedule the uplink data channel to the UE using the downlink control channel according to the present invention. The UE processor may control the UE RF unit to transmit the PUSCH within the sTTI according to scheduling performed by the eNB. The UE processor may generate a DMRS for the PUSCH using the sTTI index according to the present invention. The UE processor may control the UE RF unit to transmit the PUSCH and the DMRS. Since the eNB processor knows the scheduling information, the eNB processor may detect the PUSCH and the DMRS from the signals received on the corresponding frequency resources in the corresponding sTTI. The eNB processor may demodulate the PUSCH based on the DMRS.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

What is claimed is:

1. A method for transmitting an uplink signal by a user equipment in a wireless communication system, the method comprising:
transmitting a first uplink channel within a first transmission time interval (TTI);
transmitting a second uplink channel within a second TTI; and
transmitting a first demodulation reference signal (DMRS) for the first uplink channel and a second DMRS for the second uplink channel in a same time symbol,
wherein the first DMRS and the second DMRS are generated based on a same TTI index.

2. The method according to claim 1, wherein the same time symbol is a last time symbol in the first TTI and a start time symbol in the second TTI.

3. The method according to claim 1, wherein the same TTI index is an index of the first TTI, an index of the second TTI, floor(the index of the first TTI/2), floor(the index of the second TTI/2), ceil(the index of the first TTI/2), or ceil(the index of the second TTI/2).

4. The method according to claim 1, further comprising:
receiving information about a first frequency resource for the first uplink channel, information about a second frequency resource for the second uplink channel, and information about a third frequency resource for a DMRS,
wherein the first uplink channel is transmitted using the first frequency resource within the first TTI, the second uplink channel is transmitted using the second frequency resource within the second TTI, and the first DMRS and the second DMRS are transmitted using the third frequency resource within the same time symbol.

5. A user equipment for transmitting an uplink signal in a wireless communication system, the user equipment comprising:
a radio frequency (RF) unit, and
a processor configured to control the RF unit,
wherein the processor is configured to:
control the RF unit to transmit a first uplink channel within a first transmission time interval (TTI);
control the RF unit to transmit a second uplink channel within a second TTI; and
control the RF unit to transmit a first demodulation reference signal (DMRS) for the first uplink channel and a second DMRS for the second uplink channel in a same time symbol,
wherein the processor generates the first DMRS and the second DMRS based on a same TTI index.

6. The user equipment according to claim 5, wherein the same time symbol is a last time symbol in the first TTI and a start time symbol in the second TTI.

7. The user equipment according to claim 5, wherein the same TTI index is an index of the first TTI, an index of the second TTI, floor(the index of the first TTI/2), floor(the index of the second TTI/2), ceil(the index of the first TTI/2), or ceil(the index of the second TTI/2).

8. The user equipment according to claim 5, wherein the processor is configured to control the RF unit to receive information about a first frequency resource for the first uplink channel, information about a second frequency resource for the second uplink channel, and information about a third frequency resource for a DMRS,
wherein the processor controls the RF unit to transmit the first uplink channel using the first frequency resource within the first TTI, controls the RF unit to transmit the second uplink channel using the second frequency resource within the second TTI, and controls the RF unit to transmit the first DMRS and the second DMRS using the third frequency resource within the same time symbol.

9. A method for receiving an uplink signal by a base station in a wireless communication system, the method comprising:
receiving a first uplink channel from a user equipment within a first transmission time interval (TTI);
receiving a second uplink channel from the user equipment within a second TTI; and
receiving a first demodulation reference signal (DMRS) for the first uplink channel and a second DMRS for the second uplink channel from the user equipment in a same time symbol, wherein the first DMRS and the second DMRS are detected based on a same TTI index.

10. The method according to claim 9, wherein the same time symbol is a last time symbol in the first TTI and a start time symbol in the second TTI.

11. The method according to claim 9, wherein the same TTI index is an index of the first TTI, an index of the second TTI, floor(the index of the first TTI/2), floor(the index of the second TTI/2), ceil(the index of the first TTI/2), or ceil(the index of the second TTI/2).

12. The method according to claim 9, further comprising:
transmitting, to the user equipment, information about a first frequency resource for the first uplink channel, information about a second frequency resource for the second uplink channel, and information about a third frequency resource for a DMRS,
wherein the first uplink channel is received using the first frequency resource within the first TTI, the second uplink channel is received using the second frequency resource within the second TTI, and the first DMRS and the second DMRS are received using the third frequency resource within the same time symbol.

13. A base station for receiving an uplink signal in a wireless communication system, the base station comprising:
a radio frequency (RF) unit, and
a processor configured to control the RF unit,
wherein the processor is configured to:
control the RF unit to receive a first uplink channel from a user equipment within a first transmission time interval (TTI);
control the RF unit to receive a second uplink channel from the user equipment within a second TTI; and
control the RF unit to receive a first demodulation reference signal (DMRS) for the first uplink channel and a second DMRS for the second uplink channel from the user equipment in a same time symbol,
wherein the processor detects the first DMRS and the second DMRS based on a same TTI index.

14. The base station according to claim 13, wherein the same time symbol is a last time symbol in the first TTI and a start time symbol in the second TTI.

15. The base station according to claim 13, wherein the same TTI index is an index of the first TTI, an index of the second TTI, floor(the index of the first TTI/2), floor(the index of the second TTI/2), ceil(the index of the first TTI/2), or ceil(the index of the second TTI/2).

16. The base station according to claim 13, wherein the processor is further configured to control the RF unit to transmit, to the user equipment, information about a first frequency resource for the first uplink channel, information about a second frequency resource for the second uplink channel, and information about a third frequency resource for a DMRS, wherein the processor controls the RF unit to receive the first uplink channel using the first frequency resource within the first TTI, controls the RF unit to receive the second uplink channel using the second frequency resource within the second TTI, and controls the RF unit to receive the first DMRS and the second DMRS using the third frequency resource within the same time symbol.
